(19) United States
(12) Patent Application Publication
(10) Pub. No.: US 2017/0046769 A1
(43) Pub. Date: Feb. 16, 2017

(54) Method and Apparatus to Provide A Clothing Model

(71) Applicant: Measur3D, Inc., San Francisco, CA (US)

(72) Inventors: David T. Jackson, Redwood City, CA (US); Zoran Kacic-Alesic, Novato, CA (US); Scott M. Frankel, Berkeley, CA (US); James F. O'Brien, El Cerrito, CA (US); Tobias Pfaff, Oakland, CA (US); James L. Andrews, San Francisco, CA (US); Robert A. Backman, El Cerrito, CA (US); Edilson de Aguiar, San Francisco, CA (US); Carlo Camporesi, San Francisco, CA (US); Tyler N. Martin, Alameda, CA (US); Gregory R. Piesco-Putnam, San Francisco, CA (US); Karen M. Stritzinger, Oakland, CA (US)

(21) Appl. No.: 15/232,783

(22) Filed: Aug. 9, 2016

Related U.S. Application Data
(60) Provisional application No. 62/203,381, filed on Aug. 10, 2015.

(51) Int. Cl. G06Q 30/06; A41H 1/02

(52) U.S. Cl. CPC G06Q 30/0631; A41H 1/02; G06Q 30/0643

(57) ABSTRACT

A method and apparatus to provide a depiction of a garment model of a body shape is described. The garment model takes into account the visual and mechanical characteristics of the fabric, as well as the drape of the fabric on a body shape.

### RELATED APPLICATIONS

The present application claims priority to U.S. Provisional Application No. 62/203,381, filed on Aug. 10, 2015, and incorporates that application in its entirety.

### FIELD

The present invention relates building a computer model of a garment based on a physical sample garment, and to the process of using the computer model of a garment to determine the garment's appearance on a human body.

### BACKGROUND

Purchasers of clothing generally want to make sure that the item will be flattering, and will suit them well. Traditionally, the person would go to a store, try on clothing, and see if it worked on their body, and moved right. However, more and more commerce is moving online, and people are shopping for clothes online as well. While a photo of the clothing on a mannequin or human model can show what the clothing looks like on a model's body, it does not generally provide enough information for a user to see how that item of clothing would lay on his or her own specific body, or how the clothing would move as he or she wears it.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a network diagram of one embodiment of the various systems that may interact in the present invention.

FIGS. 2A-C are a block diagram of one embodiment of the system.

FIG. 3 is an overview flowchart of one embodiment of the system of provision of a clothing model.

FIG. 4A is a flowchart of one embodiment of pattern extraction using non-destructive disassembly.

FIG. 4B is a flowchart of one embodiment of obtaining data for an item of clothing when CAD data is available.

FIG. 4C is a flowchart of one embodiment of obtaining data from a paper pattern.

FIG. 5 is a flowchart of one embodiment of constructing a garment base pattern.

FIG. 6 is a flowchart of one embodiment of creating a particular pattern from the base pattern.

FIG. 7A is a flowchart of one embodiment of creating a body shape including a plurality of landmarks.

FIG. 7B is a flowchart of one embodiment of generating a body shape using body basis shapes.

FIG. 8 is a flowchart of one embodiment of rigging a particular pattern onto a particular body shape.

FIG. 9A is a flowchart of one embodiment of simulating and rendering the clothing model.

FIG. 9B is a flowchart of one embodiment of simulating the clothing model including a plurality of items of clothing.

FIG. 10 is a flowchart of one embodiment of an end-user interaction with the system.

FIG. 11 is a flowchart of one embodiment of enabling search by fit, based on the rigging and simulation data.

FIG. 12A is a flowchart of one embodiment of Look Book generation based on the user's data

FIG. 12B illustrates one embodiment of a Look Book which may be made available to a user.

FIG. 12C illustrates one embodiment of the differences in fitting various sizes.

FIG. 13 is a flowchart of one embodiment of generating customized clothing based on the data.

FIG. 14 is an illustration of an exemplary non-destructive acquisition rack that may be used.

FIG. 15 is a block diagram of one embodiment of a computer system on which the present invention may be implemented.

### DETAILED DESCRIPTION

### Glossary

We provide the following Glossary of Terms, which will be used in the present application:

Garment pattern: A plurality of elements, including panels, connections, embellishments, and other components that describe an item of clothing.

Non-destructive acquisition: A method of building a garment pattern that matches a physical item of clothing without taking the clothing apart, or otherwise damaging it, using a plurality of measurement systems, which may include cameras, depth cameras, rulers, and analytics.

Destructive acquisition: A method of building a garment pattern for an item of clothing by taking it apart at the seams, cutting it apart, or otherwise damaging the item of clothing, in order to take its measurements using a plurality of measurement systems, which may include cameras, depth cameras, rulers, and analytics.

CAD model: a computer-aided design model of a garment, which may be supplied by the manufacturer. It provides the measurements and general descriptions of the garment. In one embodiment, the CAD model provides information that may be used during destructive or non-destructive acquisition.

Paper Pattern: A set of diagrams or cutouts, on typically on paper (but possibly on plastic sheets or other materials) that contain the information traditionally used by garment designers to convey a description of their design to a person who would then manufacture the garment based on the design. A printed pattern may be a print out of a CAD model, hand drawn, or produced by other means.

Fabric characteristics: Information describing the properties of a fabric including the mechanical and visual characteristics of a fabric.

Fabric mechanical characteristics: Data regarding the fabric's movement and drape behavior, including mechanical response to stretch in each dimension, thickness, weight, and damping. In general the fabric mechanical characteristics provide the information needed by simulation software to compute how the fabric would drape or move. In one embodiment, the system uses adaptive remeshing to simulate how the fabric would drape on a body shape, or move as the body shape moves. In one embodiment, adaptive anisotropic remeshing is used, which utilizes polygons of varying sizes, depending on where predicted motion and wrinkling occurs in a fabric. This enables a faster simulation providing realistic details.

Fabric visual characteristics: Data regarding the fabric visual appearance, including color, fabric texture characteristics, fabric reflectance characteristics, and other appearance aspects of the fabric.

Fabric texture characteristics: Data that describe the variation in color over the surface of a fabric. These variations may be due to, for example, printed graphics, different color threads, or dyes of various colors. Fabric texture characteristics may also include variation in other qualities besides color. For example, Fabric Texture Characteristics may include information about the variation in shininess over the surface of the fabric, or more generally variation in the fabric reflectance characteristics over the surface of the fabric.

Fabric reflectance characteristics: Data that describe how light reflects of off a fabric, including shininess, sparkle, and color. Given an incoming direction of light, type of light, and a viewing direction, the fabric reflectance characteristics allow one to determine how much light from the incoming direction is reflected in the outgoing direction. Fabric reflectance characteristics may also describe transparency/translucency or phenomena such as subsurface scattering. In general fabric reflectance characteristics provide the information needed by rendering software to compute the interaction of light with a fabric and render an image depicting its appearance. Fabric reflectance characteristics may vary over the surface of the fabric in order to account for fine-scale structures. In one embodiment, fabric reflectance characteristics may be stored using bidirectional reflectance distribution function (BRDF) functions, generalizations of BRDF functions, spatially varying generalizations of BRDF functions, normal maps, numb maps, specularity maps, or other representations that can be used as input to rendering software. In one embodiment, path tracing is used to compute global illumination, which captures the subtle inter-reflections of light used to create realistic looking images.

Panels: Pieces of cloth which are attached together to create the garment being analyzed, and the virtual representation of the same. Although the term “cloth” is used for simplicity, the term is intended to encompass vinyl, leather, plastic, or other materials that may reasonably be used to construct a garment. Although the term “panel” implies a flat structure, the term is used here for simplicity and panels are not necessarily flat. In one embodiment, the piece of cloth comprising a panel may be a three dimensional structure, such as tubes or other shapes used to construct clothing. For example, a seamless undershirt may be a single panel, with the item definition encompassing the three dimensional shape. In some cases, a single physical panel may be represented as multiple virtual panels. In one embodiment, differently treated portions of a single panel may have different characteristics, and thus be treated as multiple virtual panels. For example, a knit material with different knitting patterns may have different characteristics, though they are a unitary panel.

Connections: Seams, buttons, fasteners, and other components which connect panels to each other.

Embellishments: Stitching, appliques, panel textures, graphics on underlying pattern, decorative buttons or zippers, striping and other elements featured on the pattern that are not panels or connections.

Base pattern: A pattern for a garment which is used as the basis for deriving patterns for specific garments. The base pattern typically includes the panels and connections, as well as guide points, but not embellishments or fabric specifics. The pattern may specify hems with special treatments which may include elements such as darts, pleats, folds, gathers, ruches, and other formations made by connecting the cloth in various configurations.

Pattern macro: A library of common arrangements of panels and connections, which may be utilized with the system. Common arrangements may include elements such as box pleats on the back of a man's dress shirt, cuff with buttons and pleats, French cuffs, etc. To aid in specifying a particular item, the system may allow selection from a library of pattern macros and placement of the pattern macro on a pattern. The system utilizes the pattern macro to automatically create the required panels, changes to existing panels, and connections. Such pattern macros may be adjusted for size, or may exist in a range of sizes (e.g. lapels may include thin and thick lapels.)

Positioning: The approximate location of a garment on a user's body. A single garment may have multiple potential positionings. For example, a skirt may be worn high or low, a jacket may be worn open or closed, sleeves may be down or rolled up, etc.

Guide points: Points on a base pattern which define the approximate positioning of the pattern on a model body. A single garment may have multiple sets of guide points, for example a skirt that may be worn high or low, may have a set of guide points for the high location and the low location. Similarly, a jacket that may be worn open or closed, or with the sleeves pushed up or not, may have different guide points for different configurations.

Garment model: The simulation model and rendering model of a garment, used in creating a depiction of the garment on a body shape.

Simulation model: A garment pattern along with fabric mechanical characteristics and all details that define the mechanical properties of the garment. The simulation model is the input to a computer simulation program that can then, for example, compute how the garment moves and drapes over a body.

Rendering model: A garment pattern along with fabric visual characteristics and all details that define the appearance of clothing. The rendering model is the input to a computer program that can, for example, render an image of how a specific drape of the garment would appear in a specific lighting condition.

Body basis shapes: Shape elements of a body, used to build a body shape. Such shape elements may, in one embodiment, include for example shoulders, which have a particular width and slope and thickness, or arms which have a certain length and circumference at various points. Basis body shapes may also be complete models of a human body such that a plurality of body basis shapes may be blended, or otherwise combined, to produce a specific body shape. Basis shapes may be parameterized such that biometric quantities, for example arm length or waist circumference, may be varied to produce a specific body shape.

Body shape: A complete body model, representing a specific user. In one embodiment, the body shape is built from body basis shapes, to match a user's measurements and proportions. In one embodiment, the system uses a set of models that define available body types. In one embodiment, there may be several thousand body shapes, and each body shape has a large number of measurements associated with it. In one embodiment, the body shape is defined by proportions only. Additional features, such as skin color, may be modified without altering the body shape. Body shapes may be associated with information that is needed by the rendering software in order to produce rendered images of the body shape, and information that is need by the simulation software in order to compute how a garment would physically interact with the body shape. Such interactions may include how the garment would drape over the body shape, how the garment would move as the body shape moves, or how the body shape may be compressed elastically by the garment.

Body scan: Obtaining user data to generate a body shape for the user. In one embodiment, the system may use multiple photos taken with a camera, a computer device or other systems to obtain measurements for the user. In another embodiment the system may use images from a depth camera or RGBZ camera, a gaming system, or other systems to obtain measurements for the user. This data may be used in combination with the body basis shapes, and/or other data, to compute a body shape for the user.

Surface aspects: Adjustments to a body shape that do not change how garments fit, but do change its rendered appearance, such as skin color, eye color, eye shape, hair etc.

Landmarks: Locations on the body shape that define an area located a small distance away from the actual body that are associated with guide points. Landmarks may be located, for example, on the ends of shoulders, wrists, and other points where a simulation model of a garment may be attached.

Rigging: The process of placing the garment on the body shape.

Stretch: Any local change in a material's shape that creates mechanical strain. This includes elongation but also any other distortion in the material that creates strain including compression and shearing.

Rendering: The process of generating an image or video depicting a specific garment model on a specific body shape, based on the data associated with the garment model and the body shape. In one embodiment, the rendering is done from basic data associated with the garment model and the body shape. In one embodiment, rendering may be a “re-simulation,” using as a basis a prior rendering of the garment on a similar body shape. Renderings may be generated so that the resulting image is photorealistic and appears similar to a photograph or video. Renderings may also be stylized in various artistic ways so that they appear less like a photograph and more like a drawing or other stylized depiction of the body and garment. Renderings may include false color or other visualizations that convey information that would not normally be visible. For example, a rendering might use color variation to illustrate how tight the garment fits on a given body shape. In one embodiment, a single rendering may be modified to show various types of information through layers of visualization. This may enable the user to see the rendering in a photo-realistic way, and then modify the view to see the visual representation of various aspects of the garment (e.g. tightness, warmth, thickness, etc.)

Depiction: An image or video which depicts a specific garment model on a specific body shape, based on the data associated with the garment model and the body shape. Depictions in one embodiment may be designed to appear photo-realistic so that they appear similar to how a photograph or video of the physical garment on a physical human body or mannequin would appear, or they may be visualizations that depict data such as quality of fit or tightness at various parts of the body.

### Overview

The present invention relates to building a computer model of a garment based on a physical sample garment, and to the process of using the computer model of a garment to predict the garment's appearance on a human body, and to present that garment to a user. In one embodiment, the garment may in turn be used to create customized look books, mannequins, and garments. The prediction of appearance may include rendered images or video that depict the garment on a specific human body. The prediction of appearance may also include data such as how well the garment will fit or a visualization showing how tight the garment would be at various points on the body. The process of building the computer model of a garment may include determining the mechanical characteristics of the garment, the visual characteristics of the garment, and how it should be placed on the body shape. In one embodiment, the system may further include computing motion, how the garment moves and drapes, and the lighting interaction as the body shape moves with the garment. Predicting the garment's appearance on a human body may also include the process of constructing a body shape that corresponds to a particular user.

In one embodiment, building a garment model to enable the placement of the garment model on a body shape comprises a method which includes one or more of: defining fabric mechanical and visual characteristics of an item of clothing, identifying a base pattern for an item of clothing, adjusting the base pattern to produce a specific pattern, associating the pattern with a body shape, the body shape customized to match a user, and depicting the clothing on the body shape. In one embodiment, the clothing model may be placed on the body shape in multiple configurations. In one embodiment, the clothing model may be used to render movement, to show how the clothing moves with the body.

The depiction based on the garment and body shape is designed, in one embodiment, to appear realistic, and move as the actual item of clothing would move, including deformations of the fabric, and changes to appearance based on movement, lighting, and other factors. This process generates a clothing model which is realistic and provides an enhanced experience for the observer. In one embodiment, the system may further enable the use of multiple layers of clothing, such as a jacket and a blouse, and shows the relative movements of the items of clothing appropriately. In one embodiment, the system may also compute how the body shape represents soft human tissue that may deform due to tightfitting clothing. For example, when worn tight jeans may squeeze the legs and buttocks causing them to take on an appealing configuration. In one embodiment, the system may further be used to enable a “similar fit” type search for additional items of clothing. The “similar fit” would match clothing by fabric and fit and movement.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

### System Description

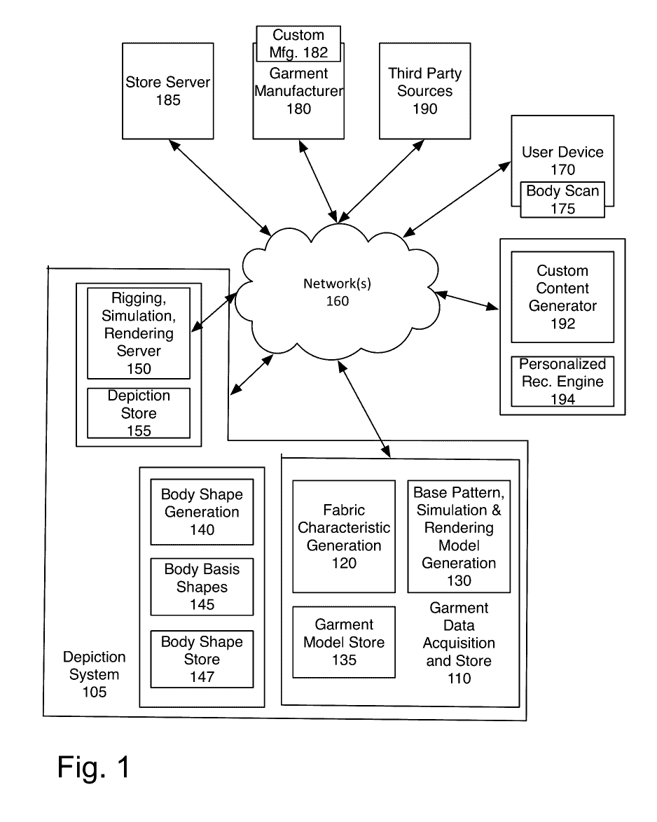

FIG. 1 is a network diagram of one embodiment of the various systems that may interact in the present invention. In one embodiment, a garment data acquisition and store system 110 is provided. This system is designed to obtain simulation models of garments. This may be done destructively or non-destructively. In one embodiment, data may be received from garment manufacturer 180 and used, alone or in conjunction with analyzed data to create simulation models of garments. Simulation models of garments stored in store 135 include data on the pattern, fabric characteristics, and how to position the garment on a user. Fabric characteristic generation 120 may obtain the data from the manufacturer 180, other parties 190, or may test the fabric and generate fabric characteristic data locally. Fabric characteristic data includes fabric visual characteristics (appearance), and fabric mechanical characteristics (simulation data).

In one embodiment, body shape generation 140 generates a plurality of body shapes corresponding to one or more buckets of “body configurations.” This includes proportions such as the relative sizes of waist, hips, bust, as well as height, arm length and other aspects of the body. In one embodiment, each person's data is compared to a set of body basis shapes and the body shape for each person is assembled from a combination of the body basis shapes. In one embodiment, a large but limited number of predetermined body shapes is available and each user is matched to the closest body shape. In one embodiment, body shape generation 140 also alters the surface aspects of the body shape, such as skin tone, hair length and color, etc. This enables a user to view an item of clothing on a body shape that looks like him or her.

Rigging, simulation, and rendering server 150 take the garment model, and the body shape, and create a depiction, which shows how the garment would appear and move in the real world. In one embodiment, the rigging positions the garment, the simulation calculates the lighting interactions and stretch and the impact on the garment of being worn, while rendering generates the output of a depiction, which may be an image, a video, or other output showing the garment's functioning on the body, stored in depiction store 155. Such a depiction is substantially different than traditional generated images of a garment on a model, or simulated “fitting” images in which a cut-out garment is represented, without showing the real impact of the curvature around the body, lighting, and movement on the appearance and movement of a garment.

In one embodiment, depictions may be made available to store servers 170, or otherwise made available to users on user devices 170. The user devices 170 may be a mobile device, such as a cell phone, tablet computer, game console, laptop, etc. The store server 185 in one embodiment, further includes a mechanism to enable matching of representations, which enables a matching of garments that would fit similarly. This type of automatically generated match by fit which be calculated based how it moves and appears around the body, does not exist currently. Current recommendations or searches make use of information about a user's preferences, past history, or other factors. However without information about the user's body shape, such recommendations and search results are often wrong. For example, two people with very similar preferences, style, and other characteristics may purchase very different clothing if one is tall and heavy and the other is short and thin.

In one embodiment, the combination of the body shape data, from body shape store 147, and the garment data from garment data acquisition and store 110 may be used by garment manufacturers 180, to optimize garment design, based on cumulative data. In one embodiment, the body shape store data 147 may be used in custom manufacturing 182, to create customized garments for a user. This enables a manufacturer, for example, to produce garments which are customized based on the user's personal information. In one embodiment, the custom manufacturing 182 may be automated, based on the garment data store 110 and the body shape data from body shape store 147.

The personalized recommendation engine 194 in one embodiment uses information that could include one or more of: body shape, user history, matches to users with similar body shapes and/or user histories, matches to users with similar search and/or purchase history, explicit preferences, and other information. In one embodiment, custom content creator 192 can create personalized look books, which display a series of clothing items, selected for the user, on a body shape matched to the user. Custom content creator 192 may also create other customized content, including advertising content customized for the user, based on the user's body shape data.

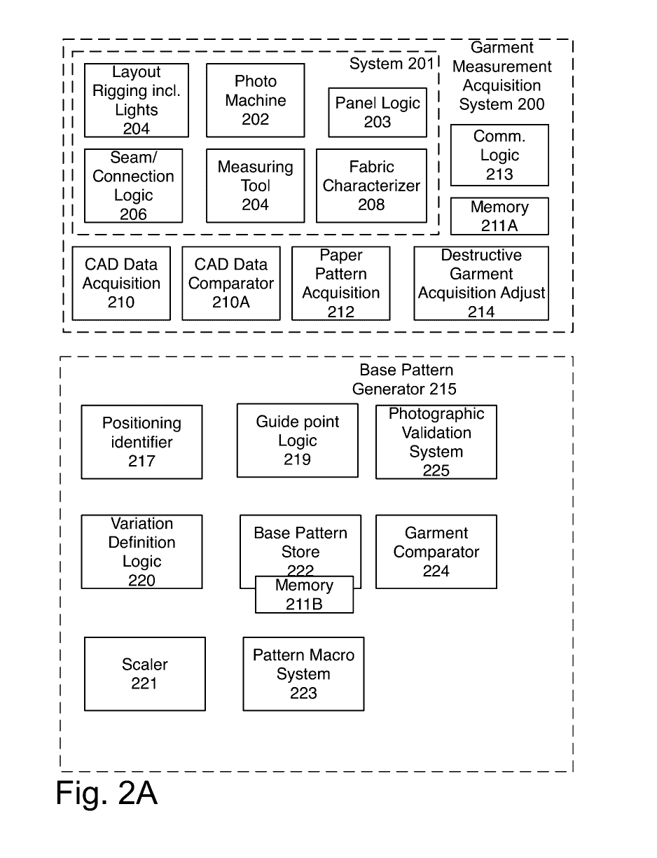

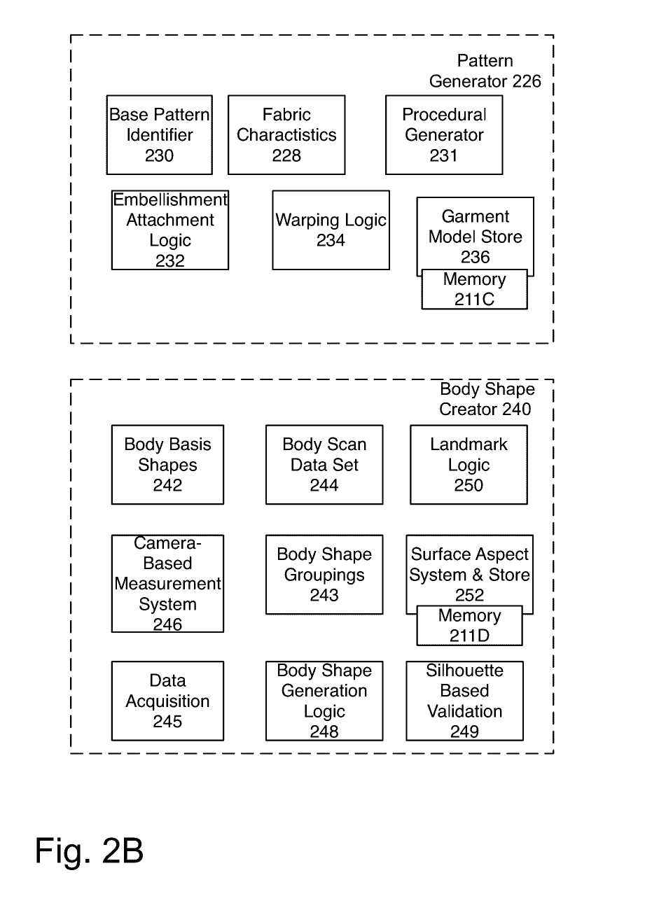

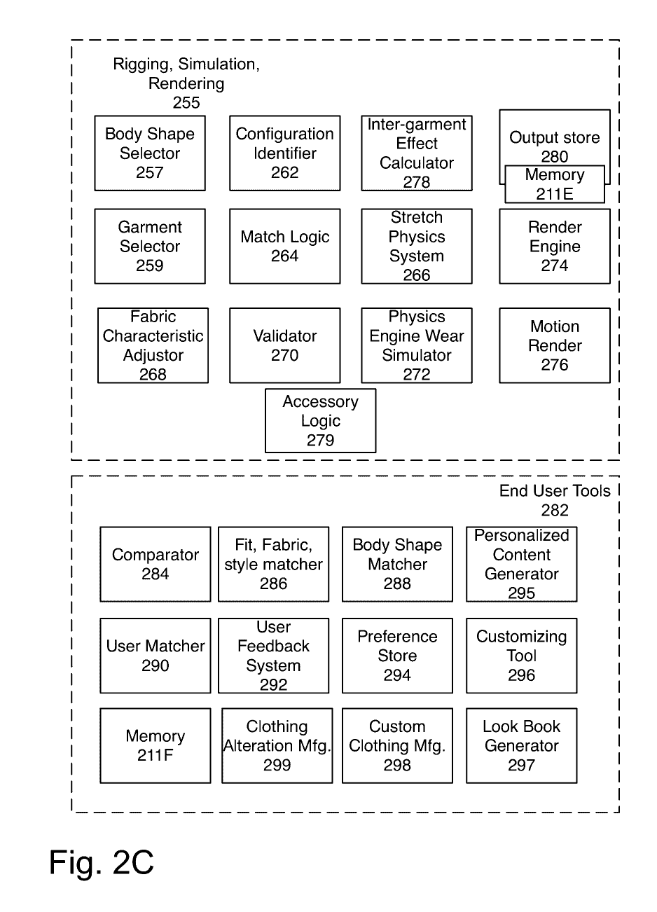

FIGS. 2A-C are a block diagram of one embodiment of the system. In one embodiment, the elements of this system are implemented on a server computer, a cluster of servers, a cloud computing system which provides computing power from a plurality of devices, or other systems providing computing power. As a general matter, each of the described elements comprises one or more algorithmic processes, executed by a computer system processor, optionally with graphical processing unit (GPU) or other such processor assistance, based on data stored in a memory. FIG. 2A illustrates the garment measurement acquisition system 200, and the base pattern generator 215. The garment measurement acquisition system 200 is used to build a garment pattern. In one embodiment, the system 200 includes a layout rigging 204. The layout rigging may include lights, such as LED lights.

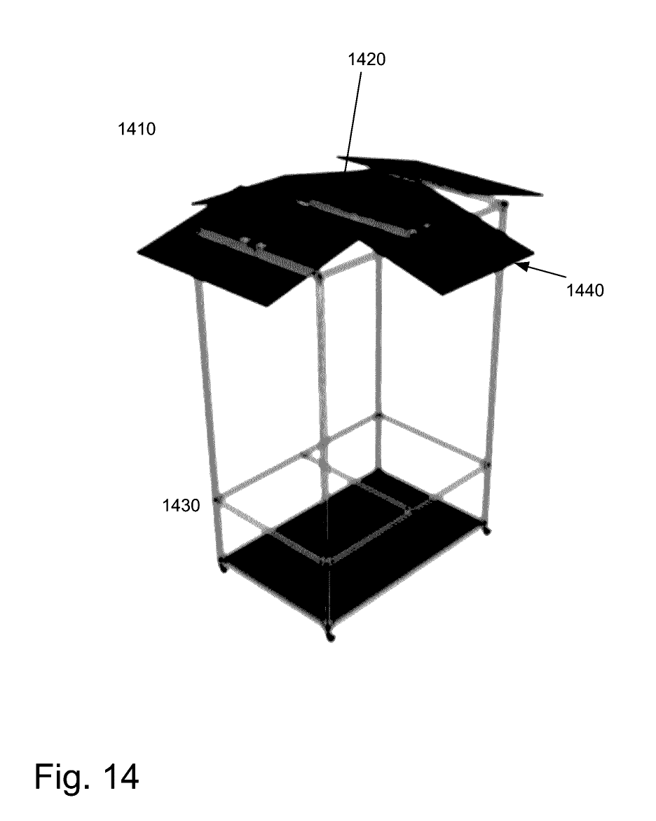

In one embodiment, the layout rigging 204 may be in the format shown in FIG. 14, with an area to place the garment, lights, and a photographic machine 202. The photographic machine 202 may be a video camera or a still image camera, or a plurality of cameras or video cameras. In on embodiment, the photographic machine 202 may include a plurality of cameras which simultaneously take images from different locations and angles, and the plurality of images may be composited to create a complete image. The rigging may be made from a metal structure to support the flat surface for the garment, and above the flat surface lights and the photo machine 202. In one embodiment, the lights are LEDs and designed to simulate various types of lighting, ranging from daylight to fluorescent. Some fabrics appear different under different lighting conditions. LED lights can also be used to simulate light from a variety of directions. In one embodiment, the system can utilize this data to provide more accurate information about a garment. Fabric characterizer 208 utilizes this information. In one embodiment, fabric characterization may be an entirely separate system which provides fabric characterization data to the garment measurement acquisition system 200, and fabric characterizer 208 attaches the characteristic data to the garments. In one embodiment, the images may also be acquired with changing directions of light, and varying types of light. This enables the rendering of fabric reflectance characteristics to capture view-dependent aspects of appearance. In one embodiment, for materials where the physical material changes as it stretches, the amount of stretch may also be varied.

Panel logic 203 defines the panels making up the garment. Most garments are made up of two or more panels, which are attached via seams or other connections. The panel logic 203 defines the panels, based on the image data obtained by photo machine 202. Seam/connection logic 206 defines the connections, by appearance, size, and type. Some garments, such as tube tops or some tank tops may lack seams, e.g. be made out of a single three-dimensional panel. Such garments, in one embodiment, are defined by panel logic 203 as a single panel. In one embodiment, a single panel may be represented as multiple virtual panels, when appropriate. Measuring tool 204 enables the measurement of the dimensions of the panel. In one embodiment, measuring tool 204 automatically measures each dimension of a panel. In one embodiment, measuring tool 204 also enables a user to adjust the measurements. For example, if a panel edge is incorrectly identified, the user may adjust it, via a user interface provided by measuring tool 204.

In one embodiment, the system includes a paper pattern acquisition logic 212. Paper patterns may be made by hand, printed from a CAD file, made with non-CAD software, or otherwise generated by a designer. The system can take measurements from the paper pattern. In one embodiment, the pattern may be scaled, by scaler 221, if needed.

In one embodiment, the system may also include CAD data acquisition 210, which receives CAD data from an external source. Communication logic 213 may be used to receive the CAD data from one or more sources. For example, the garment manufacturer may provide CAD data about its garments. The system may accept the CAD data, and utilize it instead of using the measurement system described above, in one embodiment. The system may use CAD data comparator 212 to compare the received CAD data with measured data. Sometimes, garments do not actually match the CAD dimensions, due to differences in cut or seam placement. Therefore, in one embodiment, the system may verify the accuracy of the CAD data. In one embodiment, if the CAD data matches across a plurality of garments, the system may trust the data from this particular manufacturer or source. Therefore, in one embodiment, the processor implementing the CAD data comparator 212 also makes the determination whether independent measurement through data acquisition system 201 is needed.

In one embodiment, the details about the garment, including panel, seam/connection, and fabric data is stored in a memory 211A. In one embodiment, the memory 211A is made available to other elements of the system. In one embodiment, the memory 211A may be part of a database system. In one embodiment, memory 211A may be on a separate server or device.

In one embodiment, garment measurement acquisition system 200 may include tools for destructive garment acquisition adjustment 214. Destructive garment acquisition takes apart a garment to make the measurements, using system 201. Adjust tool 214 adjusts the system 201 to enable this. This can be more accurate than non-destructive acquisition. However, destructive acquisition is generally more time consuming and more expensive. The tools of system 201 may be adjusted to be used with a destructive garment acquisition option, by adjust tool 214.

Base pattern generator 215 generates a base pattern from the data acquired by garment measurement acquisition system 200. As defined above, a base pattern is a pattern for a garment which is used as the basis for deriving patterns for specific garments. The base pattern typically includes the panels and connections, as well as guide points. As noted above, the generator 215 receives panel and seam/connection data.

In one embodiment, base pattern generator 215 includes pattern macros, which is a library of common arrangements of panels and connections, which may be utilized with the system. The pattern macro system 223 may allow selection from a library of pattern macros and placement of the pattern macro on a pattern. The pattern macro system 223 automatically creates the required panels, changes to existing panels, and connections.

Positioning identifier identifies one or more positions in which a garment may be worn. A position is the approximate location of a garment on a user's body. A single garment may have multiple potential positions. For example, a skirt may be worn high or low, a jacket may be worn open or closed, sleeves may be down or rolled up, etc. In one embodiment, the positions are identified based on the garment type and garment dimensions, identified. Positioning identifier 217 in one embodiment may provide manual adjustment options by a user. For example, generally button up shirts are not worn open. However, certain styles may be worn that way. The user may add additional positioning options beyond those identified automatically by positioning identifier 217.

Guide point logic 219 sets the guide points for the garment, based on the identified positioning(s). Guide points define the approximate positioning of the pattern on a model body. In one embodiment, there may be multiple sets of guide points. In one embodiment, for example, each position may have a letter associated with it (e.g. position A, B, and C), and each guide point may have a letter identifying whether it is associated with the particular position. For example, guide point 1 may be labeled 1AB, indicating that it is present in positioning A and B, but not C. Alternative, there may be a separate set of guide points for each positioning. However, in this instance, some of the guide points may be identical, across positionings.

Variation definition logic 220 defines variations from the measured values, that still fit within the base pattern. In one embodiment, a base pattern may encompass other garments from the same manufacturer or other manufacturers, that have very similar design. The variation range is defined by variation definition logic 220. In one embodiment, this may be done partially manually. However, in one embodiment, this may be automatic, based on a limited variation permitted. In one embodiment, a single garment in different sizes may have different base patterns, if the cut differs.

In one embodiment, during garment acquisition, a plurality of photographs, or video, is taken. Photographic validation system 225 may utilize these photographs to validate the base pattern generated, prior to storing the base pattern. If the photographs of the original garment and the base pattern do not match, in one embodiment, the system may re-generate, re-measure, alert an administrator, or otherwise attempt to ensure that the garment model is validated.

The validated base patterns are stored in base pattern store 222. In one embodiment base pattern store 222 may be stored in memory 211B. Memory 211B may be the same memory as memory 211A. Memory 211B may be a separate memory, stored in a separate device. The base pattern store 222 is used during garment generation, as will be described below.

Garment comparator 224 compares a new garment's measurement to an existing base pattern. In one embodiment, the base pattern for comparison is selected based on garment type, manufacturer, or identified pattern. If a garment is identified as matching an existing base pattern, the base pattern data is attached to the garment. If the garment is identified as not matching, a new base pattern is generated, as described above.

Pattern generator 226, in FIG. 2B, generates the actual garment pattern from a base pattern and additional information about the fabric, embellishments, and other aspects of a garment. The base pattern identifier 230 identifies the base pattern associated with a garment pattern to be generated. Fabric characteristics 228 define appearance and interaction characteristics of the material used. This may include fabric mechanical characteristics, fabric visual characteristics, fabric texture characteristics, and fabric reflectance characteristics.

Embellishment and attachment logic 232 defines the external decorative characteristics associated with a garment. By separating this aspect from the base pattern, the system can accommodate a wider range of garments in a single base pattern. Warping logic 234 calculates the change to the pattern when a garment is worn. Generally, a worn garment has different characteristics than one on a hanger, due to the fabric warping. This may change not only dimensions, but also the appearance of a garment because fabric is impacted by warping. Warping logic 234 calculates this effect.

In one embodiment, procedural generator 231 provides another way for generating a specific pattern, by taking an existing pattern for one garment and then apply a procedural re-sizing rule(s) to make a similar garment that is of different size or different proportions. For example a small size might be used to derive a medium size by following procedural rules specified by a designer that state that certain measurements should be +1″ and others +½″, or that an extra pleat should be added to the waist line of a skirt. Procedural generator 231 may also be used to pattern from a similar garment, with certain differences. For example, the procedural generator may be used to derive a long sleeved shirt from a short sleeve shirt based on rules about sleeve length increase and cuffs. In one embodiment, pattern macros may be used by procedural generator 231 to add common pattern adjustments.

Garment model store 236 stores the resultant pattern. This pattern is the garment pattern used in rendering a garment. In one embodiment, garment model store 236 is stored in memory 211C. Memory 211C may be the same as memory 211A and/or 211B. As above, it may be a separate database, server, or system.

Body shape creator 240 creates a complete body model, representing a specific user. In one embodiment, the body shape is built from body basis shapes 242, by selecting shapes from groupings 243. For example, there may be dozens of configurations of upper shoulders, which define the boniness, width, and slope of the shoulder. In one embodiment, the body basis shapes 242 may be obtained from an external source. For example, there may be a body scan data set 244 obtained, which includes a significant number of bodies. The system can derive common body shape groupings, and body shape configurations from such data. This populates the body basis shapes 242.

The actual body shape generation logic 248 utilizes the body basis shapes 242, to create the body shape. In one embodiment, the generation logic 248 can further tweak the basis body shapes, keep them within the same configuration. The body shape generation logic 248 takes the shapes 242, one of each grouping 243, and generates a complete body shape for the user. Of course, in order to do this, the system needs to have the user's data. This may be obtained by data acquisition 245 and/or a camera-based measurement system 246. The camera-based measurement system 246 may be part of a home-based system such as a KINEKT™ or other system that can take photos or videos of a user, and utilize them to make measurements. Other data acquisition mechanisms may include obtaining data from third parties, or special-purpose devices such as measurement booths, or other mechanisms. In one embodiment, the user's body data may be entered based on measurements taken by hand, and entered into a computer system.

Landmark logic 250 places the landmarks on the body shape, to which guide points are attached. Generally, body shapes 242 already have associated locations for landmarks. However, the actual data from the user may lead to adjustments.

In one embodiment, the system validates the body shape, using silhouette based validation 249. Silhouette based validation utilizes data from a camera or other data acquisition system to validate the generated body shape data against the images obtained from the actual person. In one embodiment, if the validation fails (e.g. the generated body shape does not match within a tolerance to the silhouette or image data for the user) the system may re-measure, re-generate, re-compare, and/or alert the administrator, or take another action.

The generated and validated body shape for the user, and relevant surface aspects are stored in store 252. Surface aspect include any characteristics that do not impact how an item of clothing appears on the body shape, such as skin color, hair, glasses, etc. In one embodiment, this data is taken from the camera-based measurement system 246 or data acquisition 245. In one embodiment, the user may provide still image(s) and/or video for this separately. This data may be stored in memory 211D, which may be the same as one or more of 211A-C, and may reside on a separate system. In one embodiment, body shape data may also reside separately on the user's own system, rather than in a central database. In one embodiment, the stored data includes a unique identifier for the user, and a set of codes, indicating which body basis shapes are used, and how they are adjusted (if they are), as well as relevant surface aspects. This enables the storage of very little data per user, while providing complete configurability so that the end product looks like the user.

Rigging, simulation and rendering 255 is performed in response to a user request, to see a particular garment, in one embodiment. In one embodiment, rigging and simulation is done for each combination of body shape and garment ahead of time, and upon user request only adjustments are made. In another embodiment, some set of body shape and garments are computed ahead of time and then adjustments are made to match a specific requested body shape and garment combination. Adjustments may be made more efficiently than starting from scratch.

The system uses a body shape selector 257 to select the body shape for the rigging. In one embodiment, this is the user's body shape if this is being done in response to a request. If this is done as a preliminary render, in one embodiment, a “generic” body shape is used. Garment selector 259 selects a garment for rigging. If it's the user's selection, then the appropriate size for the user's body shape is selected.

Configuration identifier 262 identifies the positioning of the garment on the body. In one embodiment, for patterns with multiple possible configurations the system may sequentially render each, select the most common, or request a selection from the user.

Match logic 264 matches the guide points in the garment to the landmarks on the body shape, for the selected configuration/positioning of the garment. This alignment defines where the garment rests on the body. Stretch physics system 266 is used in one embodiment, to stretch the garment beyond the body shape, and release it to fit onto the body shape. Validator 270 ensures that none of the parts of the garment intrude into the body shape, and that the configuration is valid. Sometimes the system may end up with an invalid configuration, for example when a larger body shape attempts to fit into a smaller and non-stretchy garment. If there is an error, the validator 270 notifies the match and physics logics 264, 266 to re-attempt. If that still fails, the error is noted.

In one embodiment, fabric characteristic adjustor 268 adjusts the appearance and characteristics of the fabric, based on the stretch/warping shown after the garment is placed on the body shape. For example, a garment fabric will appear quite different when it is significantly stretched from its base configuration, on a larger body model. Because the system has the fabric characteristic data, this can be accounted for.

Inter-garment effect calculator 278 in one embodiment adjusts the fabric characteristics (appearance as well as behavior) based on the layers worn by the user. For example, a cardigan will move differently over a velvet tank top v. over a thin cotton tank top. The inter-garment effect calculator 278 takes into account the characteristics of the fabric of each garment, and calculates cumulative effects.

In one embodiment, accessory logic 279 adds relevant accessories to the outfit, to complete the look. The accessories may include purses, necklaces, scarves, watches, bracelets, hats, and other accessories. In one embodiment, accessory logic 279 may utilize a database of accessories with relevant physical characteristics, such as movement and draping, for the final rendering. In one embodiment, such accessories may be chosen manually, based on colors, based on outfits assembled by other users, based on photographs and samples, or on another basis. In one embodiment, the accessories selected by accessory logic 279 may be made available to a user for purchase, so that the user can purchase a complete outfit.

This data is used by physics engine wear simulator 272, to generate the final output. The physics engine is used by render engine 274 to create a rendering of the body shape in motion, showing the movement of the garment. The motion render 276 provides this data. In one embodiment, the rendering may additionally provide false color or other visualization effects, indicating characteristics of the garment as worn on the body shape, such as tightness, warmth, etc.

Output store 280 stores the resultant still images and motion data. In one embodiment, the data is displayed to a user. In one embodiment, the system pre-renders garments and body shapes, and reuses the previously calculated data to render customized images and video data on-the-fly. Output store 280 may be stored in memory 211E. Memory 211E may be on the same system as the render system 255, or may be on a separate device, server, cloud, or memory storage. In one embodiment, the output of this render engine is used to make garments and accessories available to end users.

End User tools 282 provides tools for potential end users of this system who want to see garments on their own body shapes. In one embodiment, the system includes a comparator 284 which compares the user's data to other data. For example, the system may provide a fit, fabric, and style matcher 286 which matches a selected garment to other garments in the system, and provides matching garments based on how they appear. Prior art systems matched only either patterns or colors, but this system enables matching based on fit as well as how the fabric behaves on the user's body shape, as determined by the rendering system.

Body shape matcher 288 matches the user's body shape to others, to provide recommendations. User matcher 290 matches the user to others who appear to have similar tastes, based on prior purchases, preference settings, or other available data (including personal data such as location, age, and profession.) The user may provide feedback, through feedback system 292, regarding these recommendations. The user's responses are taken into account in setting up user preferences. Preference store 294 stores the data relevant to the user. In one embodiment, the system stores the matched body shapes, users, and preferences of the user. This data is used when making recommendations. In one embodiment, the preference store 294 may be stored in memory 211F. As above, memory 211F may be the same or different from memories 211A-E. In one embodiment, user preferences may be stored on the user's system. In one embodiment, user preferences are stored with the other user data, including the user body shape, and interaction history with the system.

In one embodiment, end user tools enable a user, in addition trying on a selection of existing garments, to customize a design. Customizing tool 296, in one embodiment, permits customization of existing garments in the system, and rendering them/virtually trying them on. At its simplest, the customization may permit changing in colors or embellishments. More complex would be to permit variation in fabric types. The system may also permit design changes, using pattern macros, or simulated alternatives which may be added to the selected design. For example, a shirt might have a selection of sleeve designs to chose from (short, long, bell sleeve, long with French cuffs), or the pleat arrangement could be varied (no pleat, side pleats, box pleat). Another type of customization could be varying a measurement, such as the inseam length or waist circumference. Once a customized design had been simulated, rendered, viewed, and approved, the modified design would be sent for manufacture, either by human workers or by automated devices.

In one embodiment, end user tools may also include clothing alternation and manufacturing tools 299 which may permit automatic alteration of designs to customize them for users. In one embodiment, rather than automatic alteration, the clothing alteration manufacturing tools 299 may provide information for a seamstress or other professional to make the alterations easily.

Custom clothing manufacturing tools 298 may include automatic creation, cutting, and sewing of patterns customized to the user. In one embodiment the custom clothing manufacturing tools 298 may generate the pattern, for implementation by a manufacturing company using other tools.

In one embodiment, the system can also generate personalized content, using personalized content creator 295. The personalized content may include customized advertising, web display ads, and targeting. In one embodiment, the system may utilize the matchers, to create recommendations and show them on the user's own body shape, based on what others bought, user preferences, and the user's body shape. Additional logical extensions may be available.

In one embodiment, the personalized content may include a personalized look book, created by Look Book generator 297. A look book is a physical or electronic booklet showing multiple styles, based on the available information about a user. A look book may be seasonal, thematic, or gathered otherwise, and presents multiple complete looks, which the user can purchase. In one embodiment, these complete looks may include accessories, as discussed above.

### Process Description

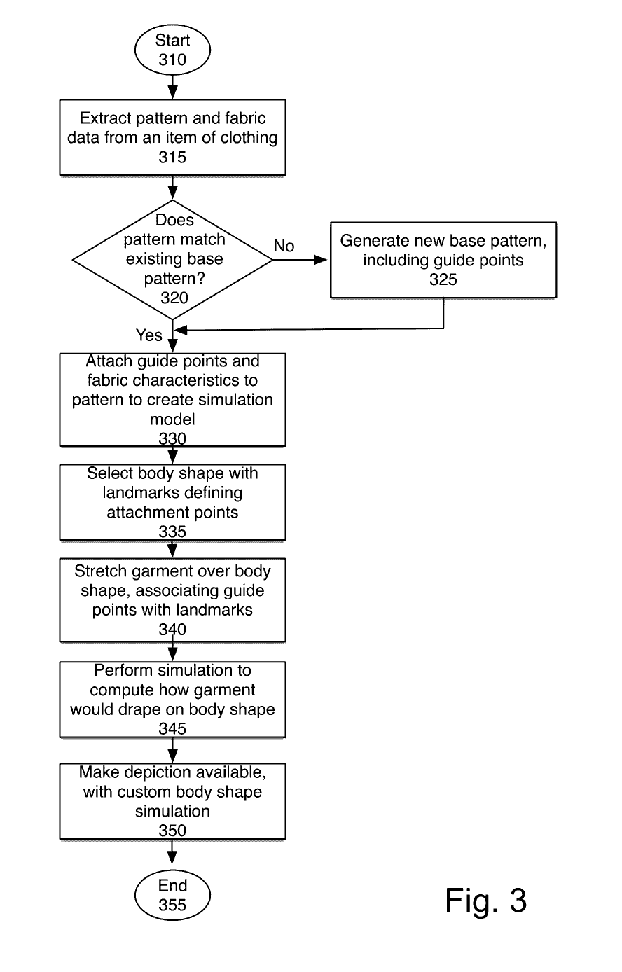

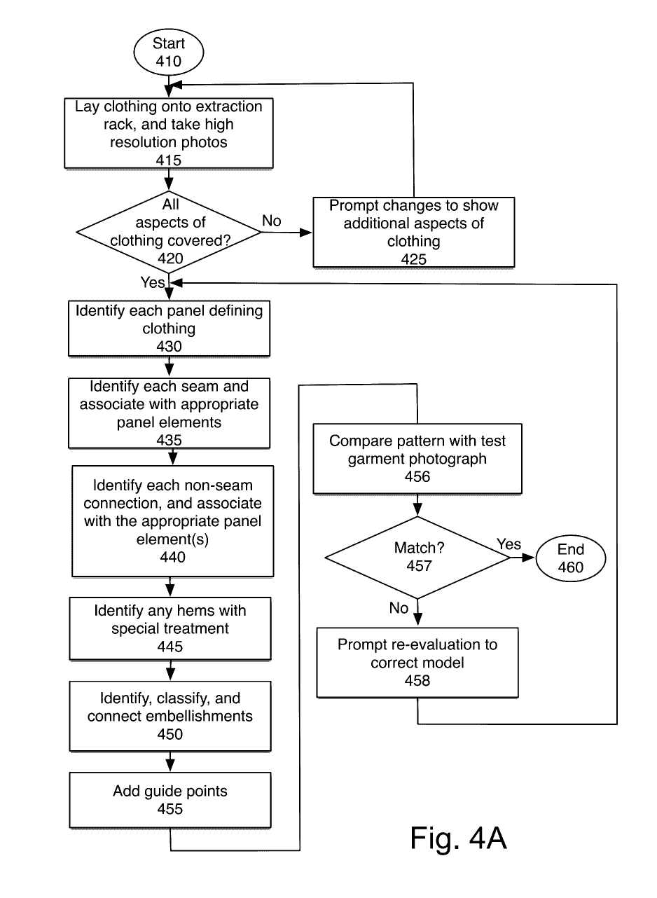

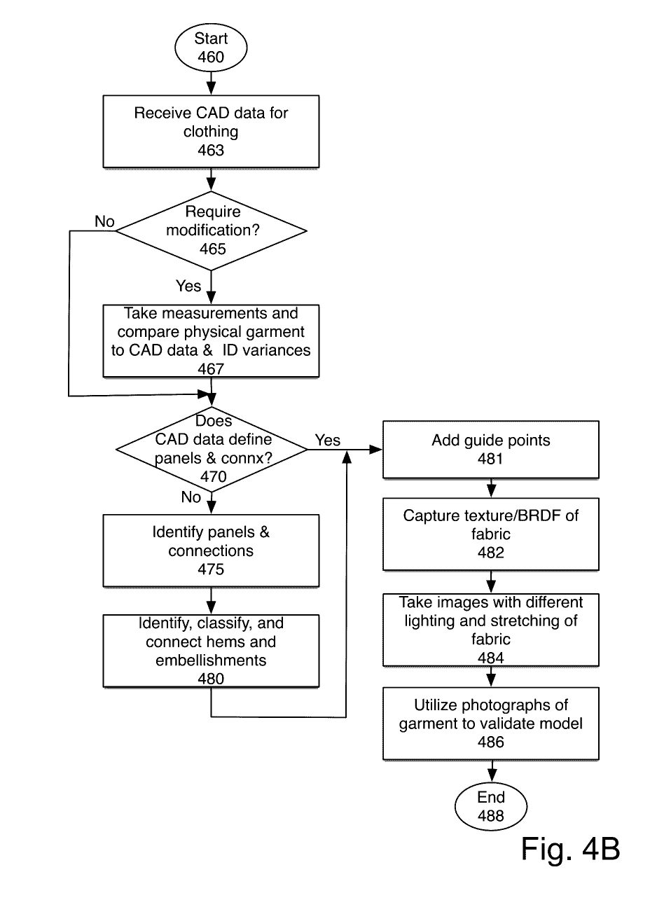

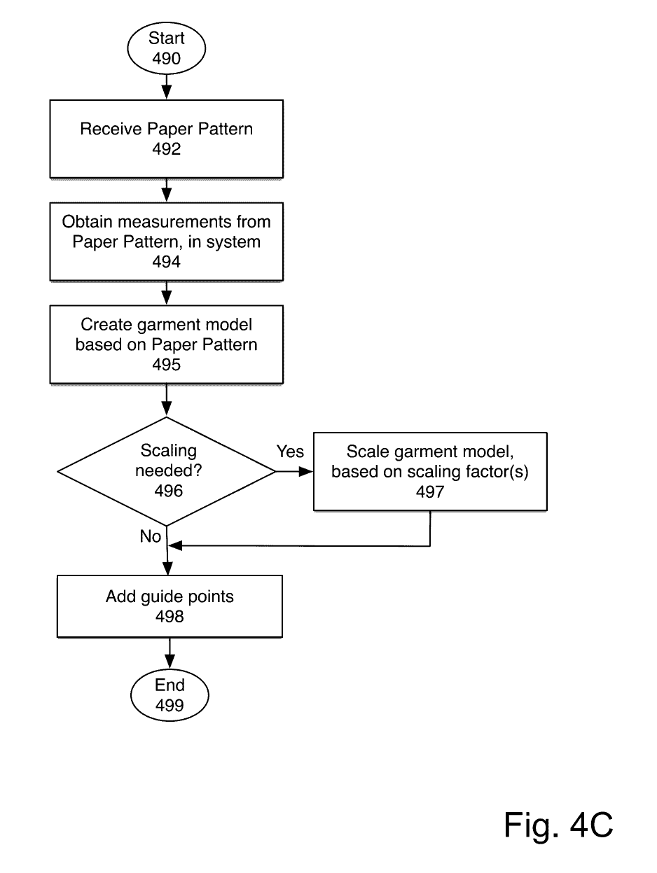

FIG. 3 is an overview flowchart of one embodiment of the system creating and depicting of one or more items of clothing on a body shape. The process starts at block 310. At block 315, the pattern and fabric data is obtained for a garment. FIG. 4 describes one method of data extraction.

At block 320, the process determines whether the extracted pattern data matches an existing base pattern. A base pattern is defined by panels and connections, and the relative sizes and attachments of those elements, in one embodiment. If the newly analyzed garment does not match a base pattern, at block 325 a new base pattern is created. A base pattern defines a pattern that is used as a basis for the actual simulation models. The base pattern has associated with it one or more guide points. The guide points define the positioning of the pattern on the body shape (simulating the appearance on an actual user.) The process then continues to block 330.

At block 330, the guide points from the base pattern are added to the clothing model. The fabric characteristics and embellishment data are also added. This creates a complete clothing model, including a rendering model and a simulation model.

At block 335, the system selects the appropriate one of multiple body shapes, based on the measurement data for the user. In one embodiment, the selection is based on the user's body scan, and designed to look similar to the user. The body shape includes landmarks defining attachment points, where garments are positioned on the body shape. A particular body shape is elected to create the representation. In one embodiment, the body shape is selected in response to user data, the body shape selected to match the user. In one embodiment, the system pre-creates the depictions, so when a user requests a particular garment, the appropriate depiction on a body shape matching the user's body is retrieved from memory.

At block 340, the garment model is stretched over the body shape, and the guide points in the simulation model of the garment are aligned with the landmarks of the body shape. In one embodiment, a garment may have multiple potential positions, and a particular position is selected for the depiction. For example, a user may wear a skirt high or low, and the body shape may include landmarks for both potential positions. The system relaxes the stretch, until the garment simulation model is in position on the body shape.

At block 345, the system performs the simulation to compute how the garment would drape on the body shape, and renders the representation of the garment model on the body shape. The simulation uses a combination of the simulation model which includes the fabric mechanical characteristics, and rendering model which includes the fabric visual characteristics. The simulation and rendering may generate still images or video. In one embodiment, the output of the simulation and rendering may be photo-realistic images and/or video. In one embodiment, rendering may also create stylized depictions of the garment. In one embodiment, the rendering may also create visualizations that convey information that would not otherwise be visible.

The output depiction data is then stored, in one embodiment. At block 350, the garment model is made available, with a customized body shape, so that user can see how a particular garment would lay, move, and appear on themselves. In one embodiment, the data is generated on-the-fly and displayed to the user immediately.

Of course, though FIG. 3, and subsequent figures, utilize a flowchart format, it should be understood that the processes described may vary from the process illustrated, and that the specific ordering of the blocks is often arbitrary. For example, the fabric analysis may be done entirely separately from the clothing analysis, or in parallel with the clothing analysis. Similarly, the generation of the various simulations and data sets may be done in parallel, or in any arbitrary order. For example, the generation of the body shapes and the generation of the garment models are substantially independent, and may be performed in any order, and at any time distance from each other.

Therefore, for this flowchart and the other flowcharts in this application it should not be assumed that just because block A follows block B, the process necessarily must flow in that directly. Only when the dependency is made clear should the ordering of the blocks be considered definitive. Furthermore, while processing is described as a flowchart, the steps may be driven by external constraints, not shown. For example, the rendering may only be done upon request, when the garment is made available for purchase, or when a user requests a particular garment. The flowcharts below similarly should not be interpreted to constrain the relationship between the process blocks, unless necessitated by interdependencies.

FIG. 4A is a flowchart of one embodiment of pattern extraction using non-destructive disassembly. Non-destructive disassembling obtains a full pattern of an item of clothing without harming the item itself. At block 415, the item is laid onto an extraction rack, and high resolution photos are taken. In one embodiment, a person positions the item. In one embodiment, the system prompts the person how to position the item. In one embodiment, the item is positioned on a highly textured, neutral colored canvas layer, and fixed using magnets. In one embodiment, the photos are taken under a variety of light conditions. In one embodiment, the extraction rack includes LED lights, enabling the system to simulate a wide range of lighting conditions. Some materials appear quite different in different lighting, and this approach enables the system to capture such variability. FIG. 14 illustrates an exemplary extraction rack that may be used. In one embodiment in addition to different types of lighting, the extraction may include different levels of stretch, for fabrics that stretch and whose appearance is impacted by the level of stretch, such as stretch velvet.

At block 420, the process determines whether all relevant aspects, such as angles, lighting, and stretch, of the clothing have been covered. In one embodiment, this determination may be automatically made by mapping out the combination of panels and seams and ensuring that each panel in the images has associated seams or hems which are present in at least one photo. If not all angles are covered, at block 425 the user is prompted to change the clothing on the rack, to show additional angles. The process then returns to block 415, to take the next set of images.

If all relevant aspects are covered at block 430 the process identifies each panel that defines the item. A panel is a continuous piece of fabric or material, which is generally attached to other parts via seams, zippers, or similar elements. Generally an item of clothing has between two and six panels, however some items may be made of a single three dimensional panel, and some complex items like patchwork jackets may have dozens if not hundreds of panels. Each panel is defined by its edges, and dimensions, in one embodiment.

The panels in garment model will generally correspond to the physical panels of cloth that comprise the actual garment. However, this correspondence is not necessary. In some cases, multiple panels of physical cloth may be modeled with a single panel. Or several panels may be used represent a single panel of physical material. This is because limitations of physical manufacture do not always apply to the system, and because the system may be subject to limitations that the real world is not.

At block 435, each seam and its connectivity is defined for each panel. Some edges of a panel may be connected to another panel via a seam. The connectivity is defined in one embodiment, by associating the portions of the panel which are directly connected. In one embodiment, the when the panel is shown separately, connectivity lines are used to associate the seam with other panel(s).

At block 440, each non-seam connection, and its connectivity, is defined. Some edges of a panel may be connected via a non-seam connection, such as a zipper, buttons, etc. In one embodiment, the specific type of non-seam connection is labeled. In one embodiment, for buttons the pattern defines the location of the buttons and the size of the button hole. However, the design of the buttons themselves are considered an “embellishment”.

At block 445, any hems with special treatment are identified. Hems are generally edges of a panel that are not connected to another panel. Special treatments may include folds, pleats, rolling, or other fabric treatment.

At block 450, the embellishments are identified, classified, and connected. Embellishments include decorative stitching, appliques, buttons, and other visual aspects of the garment.

At block 455, the guide points are added to the garment. The guide points define the positioning of the garment on a body shape. For example, for a T-shirt, the guide points may define the neckline, the tops of the arm holes, and the waist.

At block 456, the generated base pattern is compared with photographs of the test garment. This provides a visual verification that no errors were made. If the pattern matches, at block 457, the process ends at block 460. If there is no match, the system prompts a reevaluation, to correct the pattern, at block 458. The process may return to block 415, to prompt new images, or to block 430 to reprocess the existing data. In another embodiment, an administrator may correct the mismatch in the pattern generated.

At the end of this process, the system has a Base Pattern, which when combined with fabric characteristic data, can be used to create a garment model.

FIG. 4B is a flowchart of one embodiment of pattern extraction. The process starts at block 460. In one embodiment, this process may be used when the manufacturer or other third party provides CAD data. At block 465, CAD (computer aided design) data is received. The CAD data nominally defines the garment, including dimensions. Due to variance in the manufacture process, there may be discrepancies between a CAD model and the actual garment that is produced by the factory.

At block 465, the process determines whether the dimensions provided by the CAD model require modification. If so, at block 467, measurements are taken, and the measurement data is compared to the CAD data. In one embodiment, discrepancies in the CAD model are corrected using measured data and the corrected model is subsequently used. In one embodiment, the CAD data is verified for a manufacturer a number of times, initially, to ensure that it is accurate. If the CAD data consistently matches, in one embodiment the system only spot checks. If there is a discrepancy between the CAD data and the physically obtained data, in one embodiment, the system flags the manufacturer, or CAD provider, as being unreliable and verification may take place each time. In one embodiment, the measurements taken for verification are a subset of the measurements taken if no CAD data is available. In one embodiment, a subset of the CAD data that has shown previously to be mismatched is validated. The process then continues to block 470.

At block 470, the process determines whether the provided CAD data defines the panels and connections between the panels for the garment. If not, at block 475 panels and connections are identified, and at block 480, the hems and embellishments are added to the garment model. The process then continues to block 490. If the CAD data is correct and includes all of that information, the process continues directly to block 481.

At block 481, the guide points are added to the pattern. The guide points define how the garment in the base pattern is worn. In one embodiment, there may be a plurality of guide points, for a plurality of configurations.

At block 482, the fabric characteristics are captured, including texture and bidirectional reflectance distribution function (BRDF), which defines how light is reflected from the surface of the garment model. At block 484, images are taken with various lighting set-ups, and with fabric stretching. Fabric is often reactive to stretching, and stretching may alter the fabric's texture and BRDF. Therefore, in one embodiments, fabric data is obtained including the impact of stretching, and various lighting. At block 486, photographs of the garment may be used to validate the model generated. As above, in one embodiment, if the validation fails the process may return to re-measuring, re-photographing, and/or recalculating the model. The process then ends, at block 488.

The characterization of the fabric itself may be done offline, and may use a piece of the fabric rather than a garment. In one embodiment, fabric characterization data may be provided by the manufacturer or a third party. The fabric characterization may also be part of the pattern acquisition process described above. As noted above, fabric characterization may include capturing viewer-dependent aspects of appearance, utilizing various types of lighting, and stretch, to capture all of the relevant aspects of the fabric.

FIG. 4C illustrates one embodiment of using a paper pattern to obtain a base pattern. Paper patterns are used by designers to create a basis for a garment, before the garment itself is made. This enables capturing pattern data before the actual garment is made available. The process starts at block 490.

At block 492, a paper pattern is received. The paper pattern may be actual paper, or some other material which is used to create a mock-up of a garment.

At block 494, measurements are obtained from the paper pattern. In one embodiment, this may be done with the measurement system described above. However, since this is a paper pattern, no stretching or lighting variations are needed, and the panels are inherent in the pattern itself. Therefore, only dimensions and interconnections between panels need to be obtained, in one embodiment. Of course, for such patterns fabric characteristic data needs to be obtained elsewhere.

At block 495, a garment model is created based on the paper pattern. At block 496, the process determines whether the model needs to be scaled. Scaling, in one embodiment, is used in paper patterns to enable the creation of a “small” pattern for a normal sized garment. If scaling is needed, at block 497, the garment model is scaled based on the scaling factor provided with the paper pattern. At block 498, guide points are added to the pattern. The process then ends, having generated a base pattern from the paper pattern. In one embodiment, this process is adjusted by adding the embellishments and fabric data, obtained from other sources.

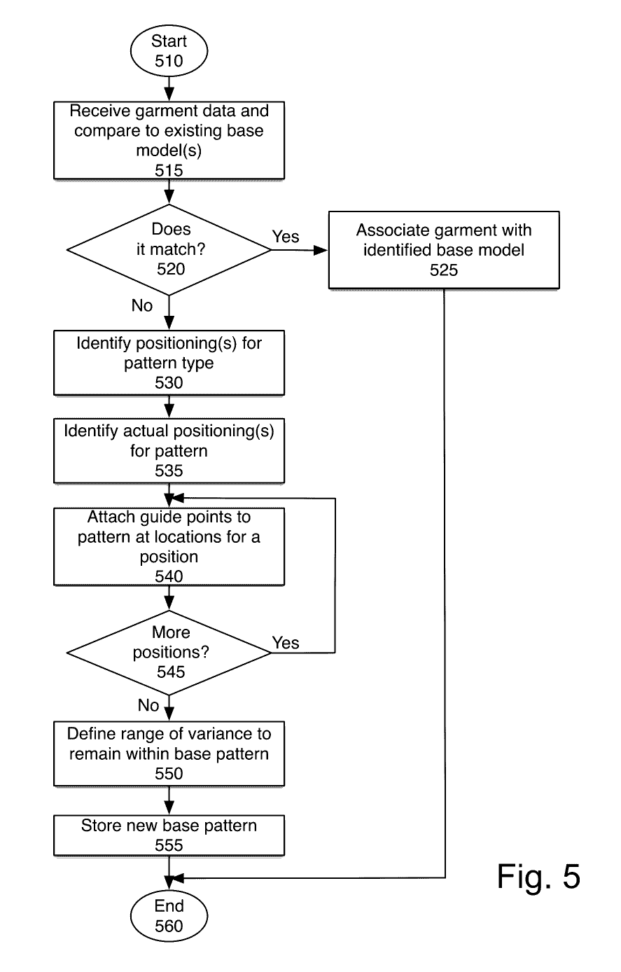

FIG. 5 is a flowchart of one embodiment of a constructing a garment base pattern. The process starts at block 510. At block 515, measurements and other data from a garment are received, and compared to existing base patterns. In one embodiment, the comparison may be based on measurements only. In another embodiment, the preliminary comparison may be on the manufacturer, identified garment type, gender, etc. The garment type is uniform in one embodiment. The garment type may be as broad as top v. bottom, or as specific as short sleeved women's T-shirt v. short sleeved women's blouse. If there are matches on the garment type, the measurements/proportions are compared. If the data for the new garment matches an existing base model, the garment is associated with that base model at block 525, This includes, in one embodiment, associating the guide points for each positioning with the new garment model. The process ends.

If the new garment does not match any of the existing base models, the process continues to block 530. At block 530, the positioning for the pattern type is identified. The positioning are the locations on a body shape where the garment may be worn. In one embodiment, a single garment may have multiple positionings, for example a blouse with an elastic neck line may be on the shoulders or off, a jacket may be open or closed, a shirt may have its sleeves down or pushed up, a skirt may be worn high or low, etc. Each of these configurations are defined by the pattern type. In one embodiment, the definitions of how each pattern type can be worn is a preliminary determination made. In one embodiment, the determination may be made using a learning algorithm by collecting images of garments worn in various ways, that are available on the Internet, and identifying the pattern types and how they can be worn.

At block 535, the actual positioning for the pattern is identified. This relates the “pattern type” positioning to the actual measurements of the particular garment which is being patterned.

At block 540, the set of guide points are attached to the pattern at the appropriate locations, for a first positioning. The guide points are designed to match locations on a body shape, to ensure that the garment is correctly positioned. In one embodiment, the set of guide points may range from 2 guide points for a simple garment such as an A-line skirt which hangs from the user's waist, to 10 or more for a garment that has a complex configuration. The purpose of the guide points is to ensure that the garment isn't positioned incorrectly (the user's head through the arm hole, or the neckline at the waist, etc.)

At block 545, the process determines whether there are more potential positions for this garment. If so, the process returns to block 540, to attach guide points at locations for this additional positioning. In one embodiment, for multiple positionings where only a few of the guide points differ, the garment has some “always” guide points, and some “position-based” guide points, so that there aren't overlapping guide points. For example, a jacket that may be worn open or closed may have a set of guide points for the shoulders and neck which are the same whether it is open or closed. In one embodiment, each potential position has a set of associated guide points.

If there are no more positions, at block 550, the range of variance to remain within this base pattern is defined. The range of variance is the range of measurements that would consider this garment of the same base pattern. In one embodiment, the variance is relatively small, so that garments associated with a particular pattern appear visually similar (excluding embellishments, which do not impact the pattern definition). In one embodiment, the differences may be larger. In one embodiment, the variation may include changes to panel dimensions, but similar relative panel sizes, e.g. the identical pattern cut in small and large has the same pattern, but different measurements. However, in many clothing items, larger sizes also use a different pattern, to account for the differences in the relative proportions of people at different sizes. The system therefore does not assume, in one embodiment, that the same garment in different sizes will be the same base pattern.

At block 555, the new base pattern is stored, and the process then ends.

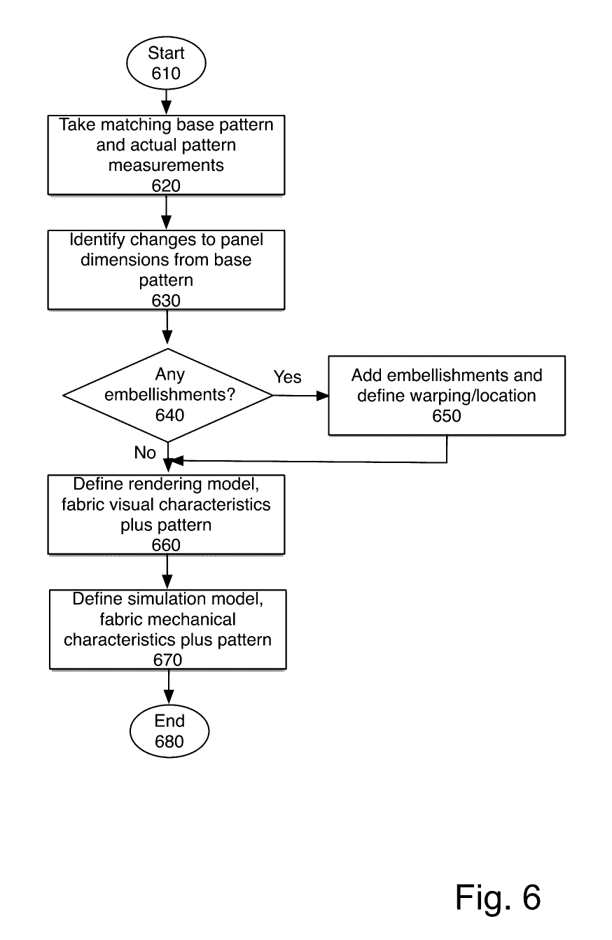

FIG. 6 is a flowchart of one embodiment of creating a garment model from the base pattern. At block 610, the process starts. At block 620, the system obtains the base pattern data, and the measured data for the actual garment.

At block 630, the changes to the panel dimensions from the base pattern are identified, if there are any. As noted above, the base pattern may encompass some variations. These variations are identified, at block 630.

At block 640, the process determines whether the garment has any embellishments. Embellishments can include stitching, appliques, buttons, and other visual additions to a garment. If so, at block 650, the embellishments are added to the garment model. This includes, in one embodiment, defining the location for the embellishments, and any warping of the underlying garment as a result of the embellishment. For example, decorative stitching can change the characteristics of fabric, as an appliques.

At block 660, the rendering model for the garment is defined. The rendering model includes the fabric visual characteristics, and the pattern. It is used for the visual aspect of the rendered garment. The fabric visual characteristics include fabric colors and patterns, texture characteristics, reflectance characteristics, and other appearance aspects of the fabric.

At bock 670, the simulation model for the garment is defined. The simulation model includes the data about the pattern and the fabric mechanical characteristics. The fabric mechanical characteristics may include mechanical response to stretch in each dimension, thickness, weight, sheen, interaction with light.

The simulation model and the rendering model together define the garment model, which includes the pattern, as well as the mechanical and visual aspects of the garment including any embellishments. The process then ends at block 680.

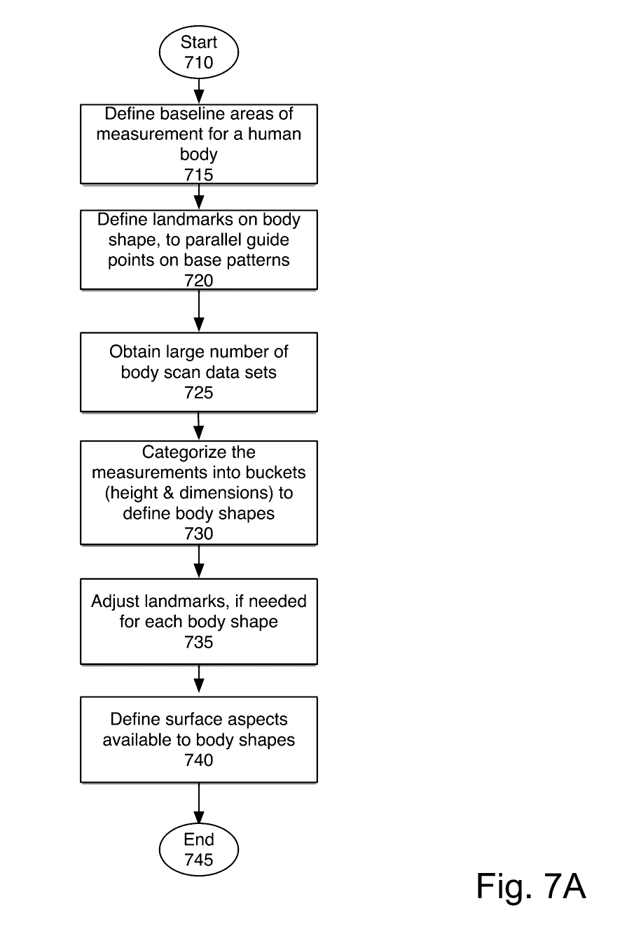

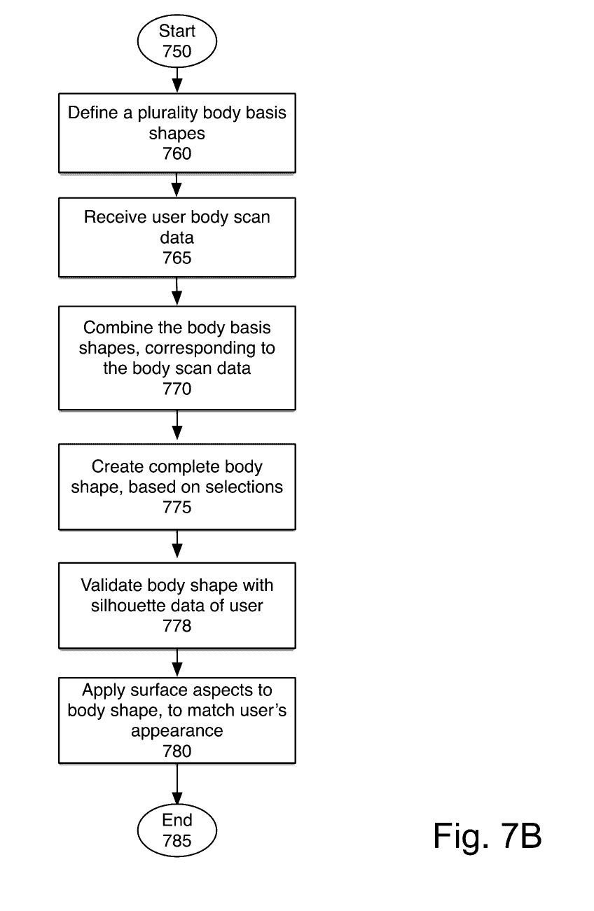

FIG. 7A is a flowchart of one embodiment of creating a body shape including a plurality of landmarks. At block 710 the process starts.

At block 715, the baseline areas of measurements for a human body are defined. In one embodiment, these are the measurements that define the shape of a body. The minimal measurements, in one embodiment, include height, bust, waist, hips. However, for accuracy, additional measurements would be used. In one embodiment, information about body shape type may be used along with measurements. For example, a specific body may be described as oval, pear, or hourglass type. Other information about the body may also be used, for example BMI (body mass index) may be used in conjunction with weight and height to estimate aspects of body shape.

At block 720, landmarks are defined on the body shape, to parallel guide points on base patterns. The landmarks define where clothing would generally fit to the body. For example, landmarks may define the neck, shoulder, arm pit, etc.

At block 725, a large number of body scan data sets are obtained. In one embodiment, the body scan data may be obtained from users utilizing a kiosk, a specialty tool, a camera, or a gaming system that includes that capability such as the XBOX 360 KINECT® by MICROSOFT®. Alternatively, body scan data sets may be purchased or otherwise obtained from third parties.

At block 730, the measurement sets are categorized into buckets, to define a plurality of “body shapes.” Each body shape encompasses a similar body, with minor variations, but generally similar in appearance and relative dimensions. In one embodiment, the body shapes in a bucket are within a small range of each other, such as no more than 0.1″ or 0.25″ difference in any of the measurements. In one embodiment, there may be hundreds or thousands of body shape buckets.

At block 735, the landmarks are adjusted for each of the body shapes, if needed. Generally body shapes would have landmarks approximately in similar places. In one embodiment, the landmarks are based on the measurements of the body shape. That is, the landmarks are not in identical locations on a body shapes of all sizes. For example a heavy/tall body may use different landmark locations than a thin/short body. But for example a woman with a oval frame may have different landmarks for a pair of pants than a woman with a hourglass frame who would have a very defined waist.

At block 740, the surface aspects available to customize the body shapes are defined. These surface aspects may include any physical characteristics that would not impact the fit of clothing. For example, skin tones, eye colors, hair color, length, and style all help define a body shape as a particular user but do not require adjustment in the fit of clothing. This data is stored, and the body shapes, customized by surface aspects, is used to provide to a viewer a body shape that matches him or her. Of course, this data may impact how the clothes look. Something that is flattering on someone with olive skin and dark hair may not look good on a pale skinned woman with gray hair.

This produces a plurality of body basis shapes. In one embodiment, these body basis shapes may be used to create customized body shapes for individual users, as will be described below. The process then ends, at block 745.

FIG. 7B is a flowchart of one embodiment of generating a particular body shape using body basis shapes. The process starts at block 750. At block 760 a plurality of body basis shapes are defined. In one embodiment, the body basis shapes are body segments that, when put together, form a full body shape. In one embodiment, the body basis shapes are a set of complete body shapes that span the range of human variation.

At block 765, a user's body scan data is received. In one embodiment, the user may utilize a kiosk that does body scanning, a system such as the KINECT™, or a camera or set of cameras to create a body scan. In one embodiment a mobile device such as a cell phone or tablet equipped with a depth camera may be used. In another embodiment, multiple photographs or videos may be assembled to crate the scan data. In one embodiment, body scanning may take multiple sets of measurements, for example with and without foundation garments. The body scan data may also include information such as body fat percentage and distribution, and other relevant information. In one embodiment, if the body scan is done with a camera, the data includes, in addition to the body scan data, appearance data as well.

At block 770, the body basis shapes combined to create a body shape for the user. The combination of shapes is selected based on the body scan data. The combination may be by combining individual body parts, by blending multiple basis shapes, or by another means. In one embodiment, a specific body shape may be formed from a linear combination of the one or more body basis shapes with weights determined to best match the scanned data. In one embodiment, the combination of body basis shapes may be nonlinear with parameters describing the nonlinear combination determined so as to best match the scanned data. In one embodiment, the body basis shapes may be parameterized to express a range of body shapes and the parameters may be selected so as to best match the scanned data. The combination is then used in block 775 to create a complete body shape that best matches the scanned data. In one embodiment the basis shapes may include a linear or non-linear set of bases that allow representation of various poses. This feature enables the presentation of the body shape in a more flattering pose, repositioning, and generation of movement, without requiring multiple scans in different poses of each individual user.

At block 778, the body shape is validated, using silhouette data of the user, when available. If the original user data is obtained with a camera or other scanner, the system has a silhouette/outline of the user's appearance, from one or more angles. The system validates the composite body shape created with the actual silhouette data. If it does not match, in one embodiment, the system may re-calculate, re-photograph, or alert an administrator of the mismatch.

At block 780, the surface aspects associated with the user are applied to the body shape, to match the user's appearance. In one embodiment, in obtaining the user′ body scan data, at least one photographic image or video data is also transmitted, enabling the system to apply surface aspects, including one or more of skin color, hair color, eye color, hair style to the body shape. In one embodiment, if the user is wearing decorative items, such as rings, necklaces, earrings, nail polish, etc., those aspects may also be used for the body shape. The goal is to produce a body shape that matches the user's appearance, so that the user sees how a garment would look on him or her. The process then ends at block 785.

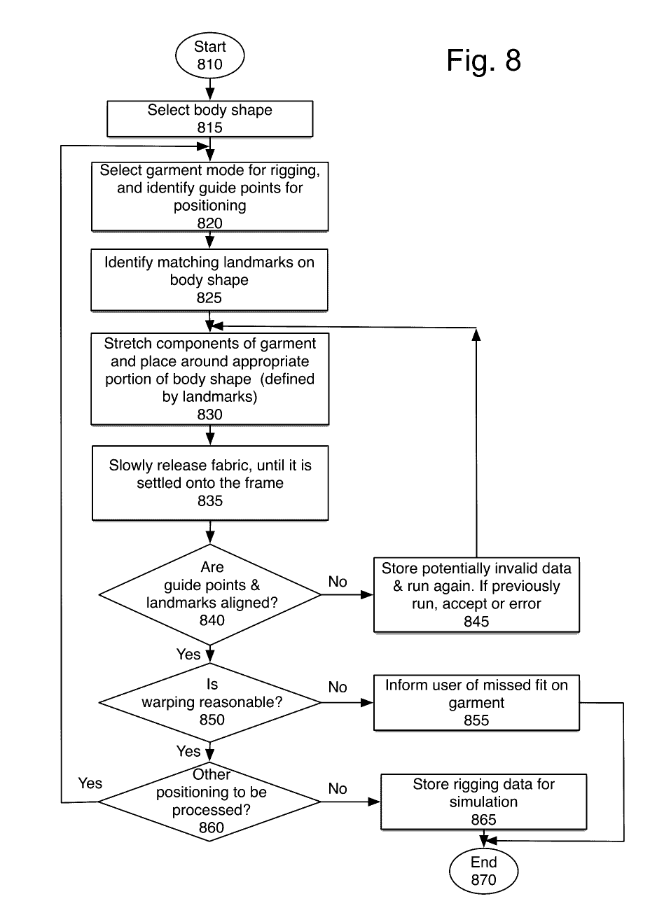

FIG. 8 is a flowchart of one embodiment of rigging a particular pattern onto a particular body shape. The process starts at block 810. In one embodiment, this process takes place prior to the system interacting with a user. In another embodiment, this process takes place on demand as a user with a particular body shape requests a depiction of a particular garment of set of garments.

In one embodiment, the system pre-computes a plurality of garment depictions such that most reasonable human measurements could be matched to the most similar depiction within a known range of error between the desired measurements and the measurements of the best matching depiction. This pre-computing may take place at any time. In one embodiment, to provide sufficient coverage, population data regarding average sizes/variations is obtained, and used to determine a minimum number of body shapes which would cover the reasonable range of human measurements. The number of body shapes defines the expected error. In one embodiment, the system uses less than a distance threshold, for such errors. For example, men's shirt collars are measured in inches, and neck measurements might vary between 12″ and 19″ for the majority of men. Creating a sufficient number of body shapes to minimize error for most users is the goal. In one embodiment, while actual neck measurements may vary between 9″ and 26″ inches, the error may be probabilistic, with smaller increments between measurements in the “common” range of 12″ to 19″, and larger steps at higher and lower sizes. In one embodiment, the range of sizes may be selected based on statistical analysis, and may differ for different types of garments (for example, bodycon type dresses may have a more limited size range than a flowing wrap dress.

At block 815, a body shape is selected.

At block 820, the garment model for rigging is selected, and the guide points for the positioning of the garment model are identified. As noted above, in one embodiment, a garment may have multiple positioning options.

At block 825, the matching landmarks on the body shape, matching the guide points, are identified. The body shape may have more landmarks than the number of guide points used for a particular garment.

At block 830, the components of the garment are stretched, and placed around the appropriate portion of the body shape, as defined by the landmarks. In one embodiment, the stretching stretches the garment a small distance past the body shape itself, and positions them. In one embodiment, the simulation placement is done by stretching the garment around the body in a physically impossible fashion, beyond the normal range of fabric stretching, and then using an optimization process to modify the initial configuration into a physically plausible one.

At block 835, the fabric is released slowly until it settles on to the frame provided by the body shape. In one embodiment, the process is designed so that the garment model settles on to the body shape naturally. However, unlike an actual garment, the garment model can be stretched infinitely along all dimensions so the stretch can be used to allow the garment model to fall onto the body shape.

At block 840, the process determines whether the guide points and landmarks are properly aligned. If not, the system determines that the data may be invalid. In one embodiment the system runs the process again. In one embodiment, the error is indicated to the user. In one embodiment, the error is marked for an administrator but not indicated to the user. In one embodiment, the system returns to block 830 to re-process. In one embodiment, if the error is accepted, or there is no mismatch, the process continues to block 850.

At block 850, the process determines whether the warping on the fabric due to the fitting is reasonable. As noted, a garment model can be stretched infinitely. However, real fabrics cannot be equivalently stretched. Therefore, at block 850 the process determines whether the fabric's final stretch, when it is on the body shape, is reasonable for a physical garment or not.

If not, at block 855, the user is informed of the missed fit on the garment. In one embodiment, the miss is shown visually, by modifying the surface appearance of the fabric, to show relevant data. For example, the system may display a color map of where the material is too tight, or making the material more shiny than normal, where it significantly stretched. In one embodiment, the process then enables the user to select a different garment for rigging. In one embodiment, the system may suggest a different size. In one embodiment, the system may automatically change the sizing of the garment. In one embodiment, the user may select a particular item of clothing, and the system may automatically select the appropriate size based on the body shape measurements.

If the warping is reasonable, at block 860 the process determines whether other positionings should be processed for this body shape and garment. If so, the process returns to block 820, to identify the guide points for the next position. If the positionings do not need further processing, the process continues to block 865. The rigging data is then stored, at block 865. The process then ends at block 870.

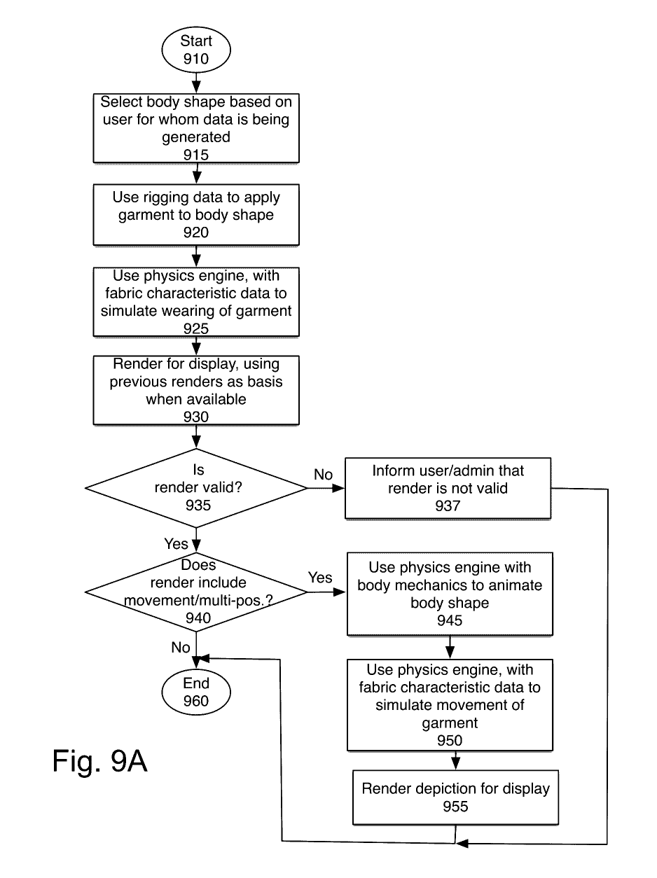

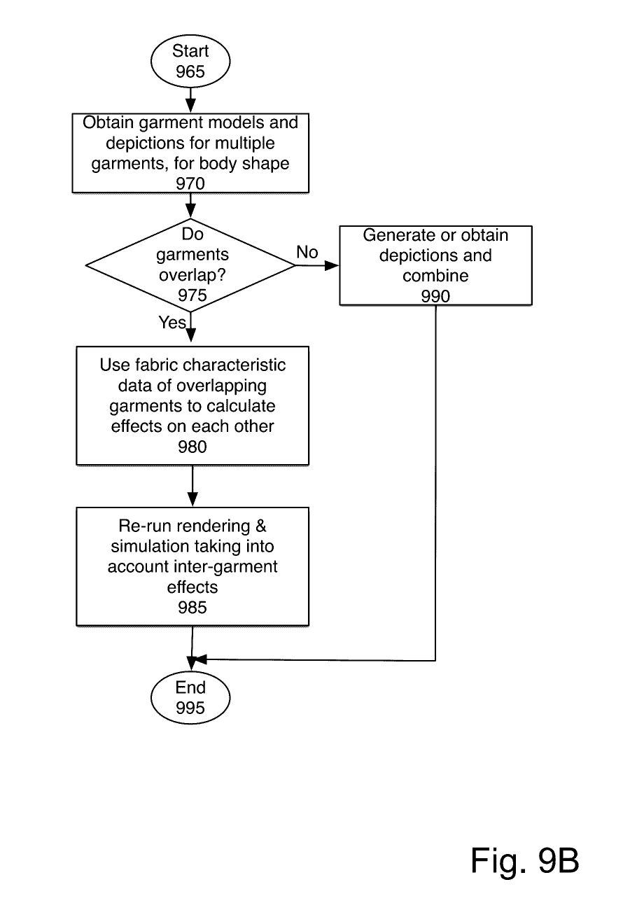

FIG. 9 is a flowchart of one embodiment of simulating and rendering the clothing model. The process starts at block 910. At block 915, the body shape is selected. Selection may be based on a user for whom data is being generated, or a database of body shapes may be processed with each body shape selected in turn. In one embodiment, the body shape may be generated from body basis shape elements, based on data from a user. In one embodiment, the simulation and rendering may take place for each potential body shape off-line, and the system may retrieve the appropriate depiction, based on the data from the user. However, for simplicity, this description will assume that the depiction is generated to match a user's data.

At block 920, the rigging data is used to apply the garment to the selected body shape. One embodiment of this process is described above with respect to FIG. 8.

At block 925, a physics engine is used, with fabric characteristic data—mechanical characteristic and fabric visual characteristics—to calculate the garment's behavior on the body shape. In one embodiment, the system uses a mesh made of a collection of polygons to represent the garment. These polygons define how the garment can fold, bend, drape, and move. Using many polygons creates inefficient simulations, but to few prevents realistic results from being achieved. Accordingly, the system may use an adaptive approach where areas that have too many polygons would be simplified to use fewer, and other areas with too few polygons would be refined to add more. In one embodiment, the optimum size/number of polygons is identified based on the stretch, bending, and other aspects of the simulated clothing fragment. For example, the waist would have more polygons than the back, and a form fitting garment would have more polygons in the stomach area than a loose fitting garment.

In one embodiment, the system utilizes simulation software to compute how the fabric would drape on a body shape or move as the body shape moved. In one embodiment, the simulation uses one of adaptive remeshing or anisotropic adaptive remeshing. In one embodiment, the implementation uses a triangle-based Finite Element Method (FEM). Adaptive remeshing adapts the size of the polygons representing the fabric, based on the areas of stretch and wrinkling and motion. Anisotropic adaptive remeshing adjusts the polygons to be aligned with the wrinkles, so not all of the polygons are the same in all directions. Triangle-based FEM is used to find approximate solutions to boundary value problems for partial differential equations, in generating the shapes. Using anisotropic adaptive remeshing speeds up the process of generating the garment draping and motion data, by providing more detail where it is needed, but reducing detail and thus complexity where it is not needed. The algorithm predicts where wrinkles will happen, with motion and draping, and adjusts the shapes accordingly.

The calculations may be based on a numerical method such as the finite element method, finite difference method, spring-mass system, or other numerical method that can be used for computing mechanical deformation. In one embodiment, when a similar prior body shape has been physically simulated with this garment or another garment based on the same base pattern, the system reuses the portion of the physics calculations that can be reused.

At block 930, the system renders the depiction, based on the calculated garment behavior, and the garment model data. In one embodiment, when a similar prior body shape has been rendered with this garment or another garment based on the same base pattern, the system reuses the portion of the rendering calculations that can be reused. In one embodiment, for similar body shapes, and similar base patterns, the system may be able to avoid re-rendering entirely, and adjust the prior rendering. In one embodiment, the system may put together a render on a similar body shape and/or a garment with a similar base pattern and/or a garment with similar embellishments, to reuse the prior calculations. This reuse speeds up the rendering process. Reuse is especially useful if the system renders the depictions live, upon request from a user. The goal is to make the system response to be seamless and near-instantaneous. Reuse may use data from one similar previously computed results or may combine data from multiple previously computed results to create a new result.

In one embodiment, the physics simulation takes into account the elasticity of human tissue. Tight fitting garments may cause compression and shaping of the underlying body tissue. Therefore, defining the body shape as a rigid object would not be reflective of the actual fit of the garment. In one embodiment, elasticity parameters consistent with human tissue define the extent to which the basic body shape can be deformed. In one embodiment, the system may take measurements and photographs, and based on the measurements determine muscle tone and body fat levels. In one embodiment, the system may also obtain body fat data directly, for example through a scale that includes that determination or using data on human physiology from other sources. In one embodiment, the system may request multiple body scan data sets, with different types of garments, and use this data to calculate elasticity/compression. In one embodiment, body shape for a user thus has a base body shape, and an associated elasticity. In one embodiment, the body shape may have an elasticity for each body part. The system, in one embodiment, models the elastic interaction between the body shape and the garment model, based on the relative elasticity and deformation of each.

In one embodiment, to create an accurate representation of a garment, global illumination is utilized. In one embodiment, a “path tracing” algorithm is used for computing “global illumination.” Global illumination captures subtle inter-reflections of light that are critical to making realistic looking images. Generally, correct illumination requires rendering how the light leaves a light source, and strikes the surface, including indirect illumination and bouncing of the light. Additionally, subtle effects, such as light bouncing off from a color are taken into account, since they have an effect on the visual appearance of a garment. Path tracing traces each path that photons could travel on, on stochastically sampled paths, to determine which paths light travels on to generate the images.

In one embodiment, renderings may be stylized in various artistic ways so that they appear less like a photograph and more like a drawing or other stylized depiction. Renderings may include false-color or other visualizations that convey information that would not normally be visible. For example, a rendering might use color variation to illustrate how tight the garment fits on a given body shape. In one embodiment, the user may switch between a “real” render and a render to highlight data such as tightness/stretch or other relevant aspects of how a garment would fit.

At block 935, the process determines whether the proposed render is valid. Invalid results may include results where the garment is not sized in a way that is possible to fit on the body. For example the garment is too large for the body shape and would fall off, or too small and it would tear or be uncomfortable. In one embodiment, this may be done by analyzing the rendered images. In another embodiment, this may be done by comparing the geometric configuration of the clothing relative to the body model. In one embodiment, this may be done before the rendering is completed. In one embodiment, the test may also use simulation data, such as fabric strain or contract pressure, to determine if the result fits the body properly. In one embodiment, in some instances the test may also use a human to inspect results where the automated tests do not produce conclusive results. If the proposed render is not valid, the user is informed, at block 937, and the process ends. Alternatively, the system may suggest an alternative garment that is larger, smaller, or has more flexibility.

At block 940, the process determines whether the render includes movement, or a plurality of positions. The rendering in one embodiment, comprises creating a static image, and short moving image showing how the garment would appear on a user while the camera and/or the user is moving. If there is no movement render, the process ends at block 960.

If the render is to include movement, the process continues to block 945. At block 945, a physics engine using body mechanics animates the body shape. In one embodiment, the default movement animation is a simple motion such as walking. The garment movement during the animation is calculated using a physics engine, at block 950. Note that the garment movement is impacted by the body movement. For example, as a woman in a skirt is walking, her hips are moving, and that would impact the garment movement.

In one embodiment, the physics simulation also takes into account the movement of human tissue as the body moves. This movement may be due to tight fitting garments that cause compression and shaping of the underlying body tissue, due to inertial effects of human tissue, due to muscles shifting as they are exerted, or due to other factors that cause motion of human tissue. In one embodiment, the depictions adjusts the poses of the body shape based on the measurements of the body shape. For example, a heavy body would have the arms more spread out so that they did not intersect the body, while a thin body might have them less spread out to make a more natural pose. In one embodiment, parts of a simulation may be reused. For example, when a garment has been simulated on a body shape and now needs to be simulated on a similar body shape, processing may be saved by starting the simulation using the output from the similar body.

At block 955, the depiction is rendered for display. The depiction shows the body shape, with the garment, moving in a predetermined way. In one embodiment, the animation sequence may be controlled by the user, e.g. the user may choose to create a depiction of running v. walking, or of dancing v. running, etc. In one embodiment, the user may choose from a plurality of possible movements for the animation. The process then ends at block 960.

FIG. 9B is a flowchart of one embodiment of simulating the clothing model including a plurality of items of clothing. As a general matter, a person wears multiple items of clothing, therefore, in one embodiment, the body shape should be able to illustrate an outfit, not just a single item of clothing. The process starts at block 965.

At block 970, the garment models and depictions for each of the plurality of garments is obtained. At block 975, the process determines whether the items of clothing overlap. When multiple items of clothing are layered, the fabrics move, warp, and stretch differently, because of the interaction between the layers. If the garments do not overlap, at block 990, the depictions are generated or obtained if they were previously generated, and combined. The multiple layers of cloth interact with each other through collisions, contacts, or constraints. The process then ends at block 995.

If the garments overlap, as worn, in one embodiment, this is determined based on the guide points associated with each garment, the process continues to block 980.

At block 980, the fabric mechanical characteristics for overlapping garments are calculated, or the characteristics are adjusted for the overlap. For example, something being worn over a silk camisole will move differently than the same garment work over a tweedy shirt, because of friction. Therefore, in one embodiment, the system adjusts the fabric mechanical characteristics for each of the garments, based on the impact of the other overlapping garments.

At block 985, the rendering and simulation are re-run, taking into account this effect on the fabric mechanical characteristics, and inter-garment effects. For example, if a jacket is worn over a thick sweater, the positioning of that jacket is different from the jacket being worn over a camisole or nothing. The updated depiction is then made available. The process then ends at block 995. In one embodiment, re-running the simulation and/or rendering may make use of existing data where the items of clothing were simulated or rendered separately, in order to gain reduced computation times.

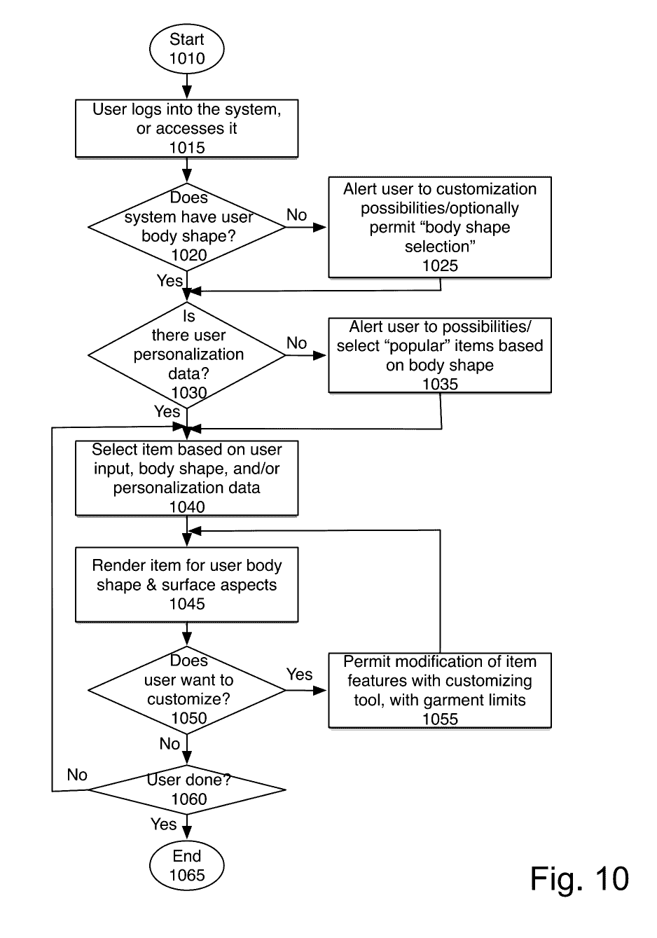

FIG. 10 is a flowchart of one embodiment of an end-user interaction with the system. The process starts at block 1010. At block 1015, the user logs into the system, or accesses it. The system may include a browser based or application based system.

At block 1020, the process determines whether the system has the user body shape. The user's body shape may be obtained from measurements, photographs, a measuring booth, or other mechanism that enables the system to obtain precise matching data for a user. If there is no user data, at block 1025, the user is alerted to the customization options. In one embodiment, the user may do some customization, based on user interface selections. However, this is not as close a match as would be obtained from proper measurements.

At block 1030, the process determines whether there is user personalization data. Personalization data describes user preference information, which may be used to customize selections for the user.

The process then continues to block 1040. At block 1040, one or more items are selected for the user. In one embodiment, the items are selected based on user input, body shape, and personalization data, when that is available. User input, for example, may include an indication that the user is looking for a dress shirt, or a dress. In one embodiment, when no data is available, the user may be asked to select a body shape & personalization details, as in conventional systems (e.g. height, weight, body shape, and general style.) That information may be used to select the item. In one embodiment, if no data is available, the system may simply select the most popular item for presentation to the user.

At block 1045, the system renders the item for the user. In one embodiment, this may include newly rendering the data, for the user's body shape. It may be altering an existing rendering to match the user's information. It may be retrieving a previously rendered version, within a margin of error from the user's body.

At block 1050, the system determines whether the user wishes to customize, in one embodiment. Customization may be available for some or all items. In one embodiment, customization may include variations such as changes in fabric, color, or other aspects. In one embodiment, if customization is available, at block 1055 the user is permitted to modify the garment within the limits of that garment. For example, a garment may be limited to altering certain embellishments or characteristics, or may be able to be rendered with various collar shapes or cuffs, that may be customized. For example, customization may include: adding embellishments such as embroidery, changing the length on a pair of pants or shirt, changing a fabric used, altering collar shapes, adding or changing cuffs, changing the type of sleeve, adding pleats, etc. The process then returns to block 1045, to render the modified item. In one embodiment, the previously rendered data is re-used, and only those aspects changed by the modification are re-rendered. For example, if the user alters the pleating, that may alter the area around the pleating, but will not alter how the sleeves appear.

At block 1060, the process determines whether the user is done. In one embodiment, the user may be done when he or she determines which items to purchase, or ends the session. If the user is not yet done, the process returns to block 1040, to select another item to render. The process then ends at block 1065. Although the flowchart ends, in one embodiment, the user may select one or more of the rendered and optionally customized items to order. In one embodiment, a conventional online shopping mechanism may be used to provide these features.

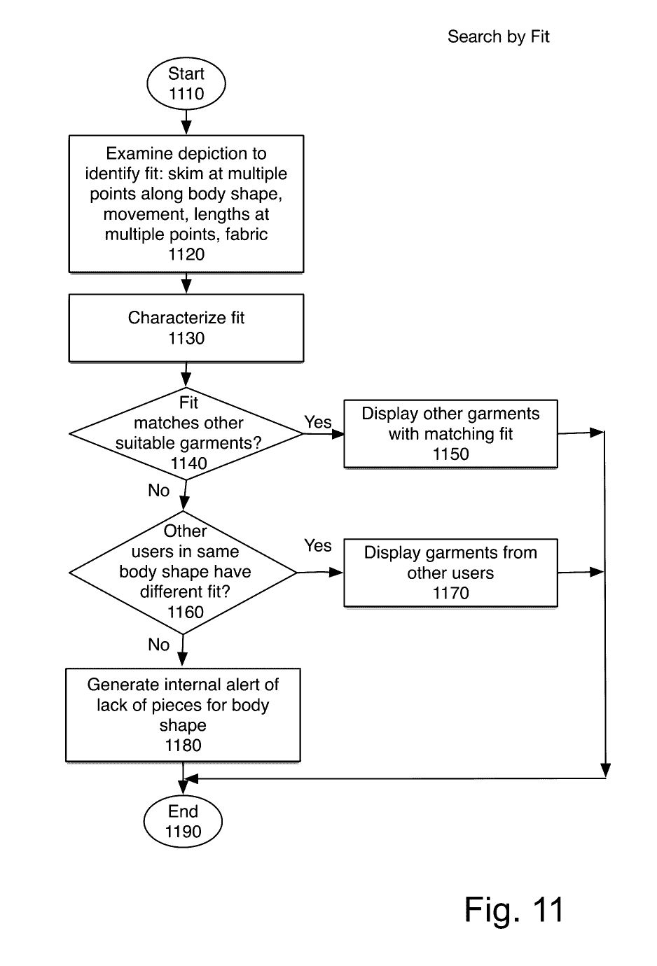

FIG. 11 is a flowchart of one embodiment of enabling search by fit, based on the rigging and simulation data. The process starts at block 1110. In one embodiment, this process starts when the user has viewed a particular garment model on their body shape, and has requested additional garments that have a similar fit. In another embodiment, this may be automatically initiated when the user interacts with the system. In one embodiment, the system permits search by fit. Search by fit would, in one embodiment, search for items that have the same base pattern, or that have different base patterns but a similar fit otherwise.

At block 1120, the process examines the depiction to identify fit. Fit is based on the tightness, skin, movement, lengths at multiple points and the fabric mechanical characteristics. Fit may also be based on more complex models that take into account data from user surveys, user purchasing habits, or other data.

At block 1130, the fit is characterized. In one embodiment, the characterized fit defines one of a plurality of types of fit. For example, a shirt may have a tight torso fit, loose straight sleeve fit, and a fluttery fabric fit. In one embodiment, this characterization uses the rendering of the garment model on the user's body shape, since fit differs by the relative sizes of the garment and body. In one embodiment, the fit may be by clothing portion, e.g. there may be fit characterization at the waist, at the chest, at the shoulders, and the arms, for a shirt.

At block 1140, the process determines whether there are other garments that would fit similarly If so, those garments are displayed, at block 1050. In one embodiment, the garment is displayed by presenting to the user multiple depictions of the same garment where each depiction shows a different configuration of the garment, pose of the body shape, or viewpoint. In one embodiment, the garment is displayed using a short rendered video, showing the garment in motion. In one embodiment, rather than rendering actual video, the system renders a sequence of poses, which are combined into a short video.

The process then ends. In one embodiment, additional garments that are somewhat similar but do not match in fit, and that are popular with others of a similar body shape, may be displayed to the user as other options.

If no suitable garments are found, at block 1160 the process determines whether other user with a similar body shape have a different fit. In one embodiment, the system displays garments from other users that had a similar fit on other users as their fit for this garment. If that is also not available, an internal alert is generated to indicate that there are a lack of suitable pieces with this fit. In one embodiment, the system may permit the user to set an alert, when additional garments are added to the system that meet the user's fitting request. The process then ends at block 1190.

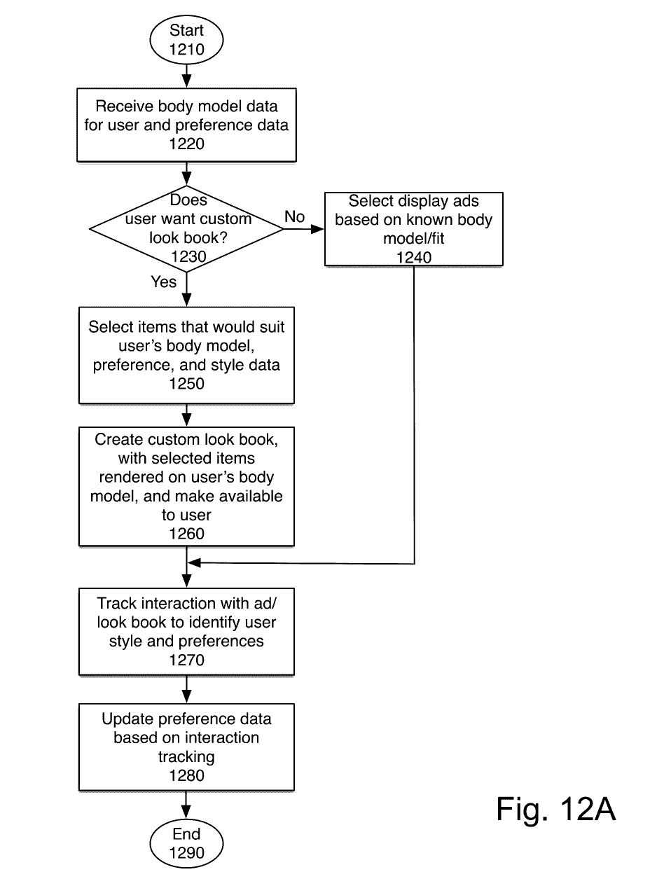

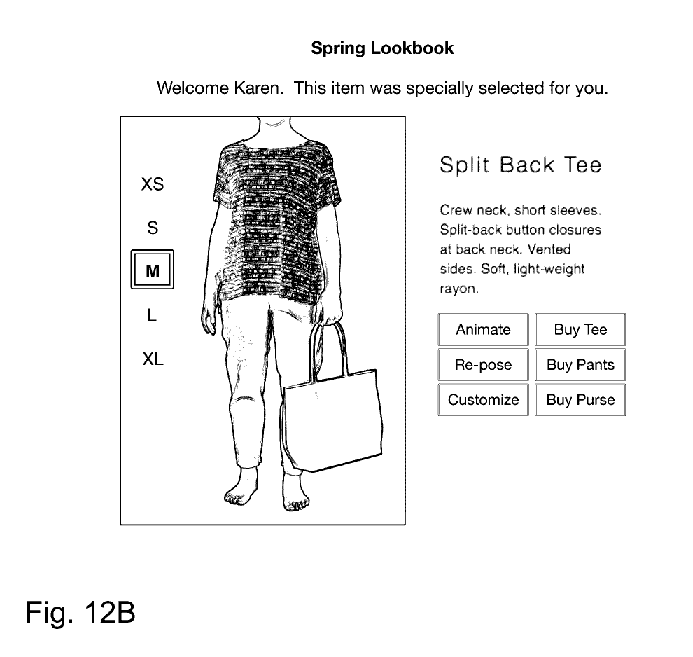

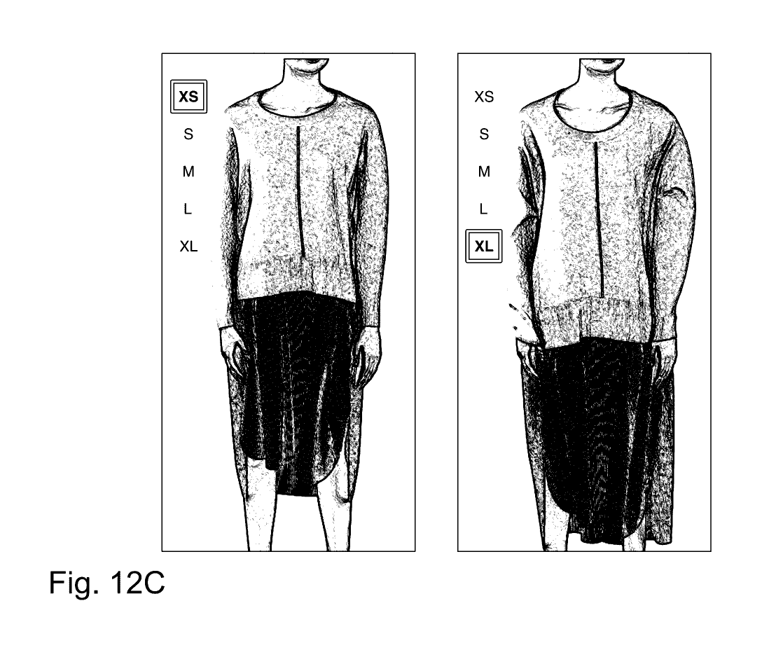

FIG. 12A is a flowchart of one embodiment of Look Book generation based on the user's data. The process starts at block 1210.

At block 1220, body model data and preference data is received for the user. In one embodiment, the data is collected continuously regarding the user's preferences. In one embodiment, the data is received when the user opts into the look book.

At block 1230, the process determines whether the user wants a custom look book. A custom look book is customized for the user's body. In one embodiment, the look book is an electronic look book. In another embodiment, the look book may be a printed look book. In one embodiment, the look book may be a custom application on a mobile device such as a tablet.

If the user does not want a custom look book, at block 1240, display ads are selected based on any available data, but not customized to the user. The process continues to block 1270.

If the user does want a custom look book, at block 1250, items are selected that would suit the user's body model, preference, and style data. In one embodiment, the selection is based on previous purchases by other users who are similar.

At block 1260, a custom look book is created, with the selected items, rendered for the user's body model. In one embodiment, the look book includes coordinated outfits, including accessories. FIG. 12B illustrates one embodiment of a Look Book which may be made available to a user. In one embodiment, the look book may provide the opportunity to view various poses, customize clothing, and animate the body shape. The user may also purchase any of the items in the look book, in one embodiment.

Returning to FIG. 12A, at block 1270, the interaction with the ad or look book is tracked. This is used to identify the user's style and preferences. In one embodiment, when the user interacts with the clothing item, where interaction may be viewing different poses or customizations or purchase, the system indicates that the user is interested in this particular style.

At block 1280, the preference data is updated based on the interaction tracking. The process then ends at block 1290.

FIG. 12C illustrates one embodiment of the difference in fit, between a well fitting item (shown on the left) and an overly large item (shown on the right). In one embodiment, the system automatically selects the items that would fit the user's body. However, a user may prefer a larger item, more baggy look, or a more closely fitted item. In one embodiment, in the Look Book of FIG. 12B, the user may change the sizing from the systems automatic determination of the optimal fit to the user's preferred look for a fit. The newly resized garment would then be fitted onto the user's body model as discussed above. In this way, the user can see how a particular garment would fit his or her body, and can customize for tightness/looseness, length, etc.

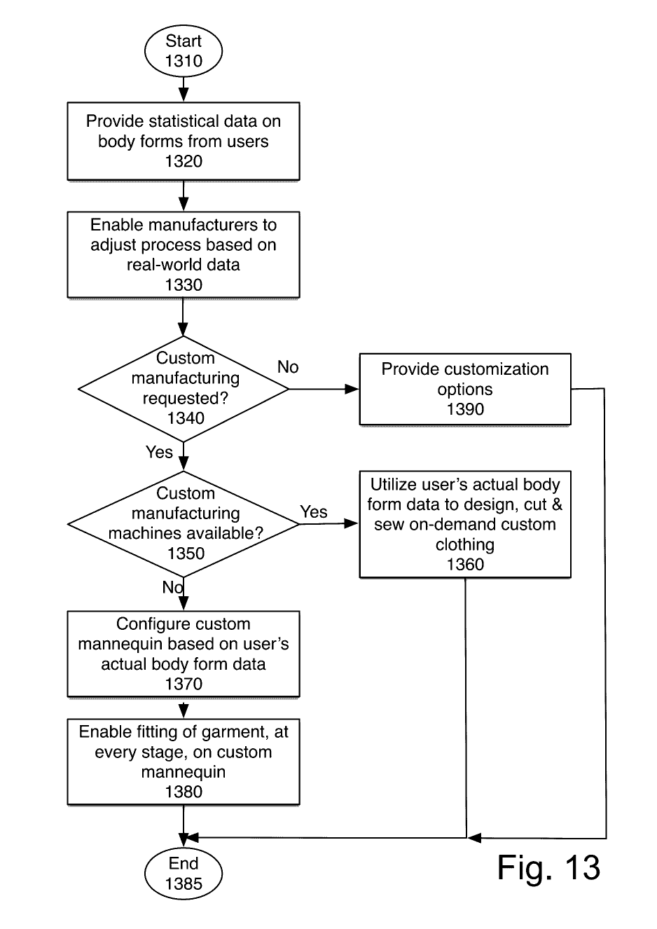

FIG. 13 is a flowchart of one embodiment of generating customized clothing based on the data. The customized clothing may be custom manufacturing or providing customization data to manufacturers. The process starts at block 1310.

At block 1320, statistical data collected from all users of the system are provided for body forms. The statistical data collected may enable, at block 1330, to adjust their process on real-world fit data. This can be useful for general design purposes, not merely for one-off customization.

At block 1340, the process determines whether custom manufacturing is requested. If not, at block 1390, customization options are provided. This enables semi-custom clothing creation, for example, providing variations in materials, embellishments, and similar aspects of a garment that do not require custom manufacturing. The process then ends at block 1385.

If, at block 13450 custom manufacturing is requested, the process continues to block 1350. At block 1350, the process determines whether custom manufacturing machines are available. Custom manufacturing machines can utilize design data, such as the pattern and sizing data to automatically create a garment.

If custom manufacturing machines are available, at block 1360, the system utilizes user's actual body form data to design, cut & sew on-demand custom clothing. The process then ends at block 1385.

If no machine is available, at block 1370, a custom mannequin is configured based on the user's actual body form data. In one embodiment, the mannequin may be automatically customizable. In one embodiment, the system may output the adjustments needed for a standard adjustable mannequin to customize it to the user's body shape.

At block 1380, the system enables the use of a the customized mannequin at every stage, to enable the making of a custom garment fit to the actual body of the user. In this way, in one embodiment, the system allows custom garment manufacturing, whether using professional seamstress or a customized machine. The process then ends at block 1385.

FIG. 14 is an illustration of an exemplary non-destructive acquisition rack that may be used. The rack in one embodiment includes a structure 1440 including a plurality of multi-color LED lights. In one embodiment, the multicolor LED lights are LED strips or panels, which can be set to emulate natural and artificial light, as well as providing light from various angles at various intensities. In one embodiment, the LED lights can be controlled individually or in groups to simulate lighting from different directions. This enables the use of a rendering method called “path tracing” which is a specific algorithm for computing “global illumination.” Global illumination captures subtle inter-reflections of light that are critical to making realistic looking images. Generally, correct illumination requires rendering how the light leaves a light source, and strikes the surface, including indirect illumination and bouncing of the light. By capturing various illuminations, enough data is captured to enable correct rendering, as described above

The structure further includes a camera, or a plurality of cameras 1420, attached to the overhead structure. The camera has a remote controlled shutter, such that the photos can be taken without any direct human intervention or controlled by a computer program.

The item of clothing is laid out on the flat 1430. In one embodiment, the flat 1430 or stage portion of the rack is comprised of a ferrous metallic sheet overlaid on a substrate material, allowing the use of magnets to help keep garments in place during capture. In one embodiment, highly attractive neodymium rare earth magnets are used. In one embodiment, the stage 1430 is surfaced with a highly textured, neutral colored canvas such that the friction between surface and garment aids in flattening the garment. In one embodiment, the area includes measurement tools, such as millimeter markings or other indicators of the actual dimensions of an item. In one embodiment, in addition to laying out garment pieces, the acquisition rack enables the stretching of a garment, to capture the effects of distortion on the fabric appearance and color. The photos are taken on this rack, and then a special purpose computer system processes the data to obtain the characteristic information, as described above.

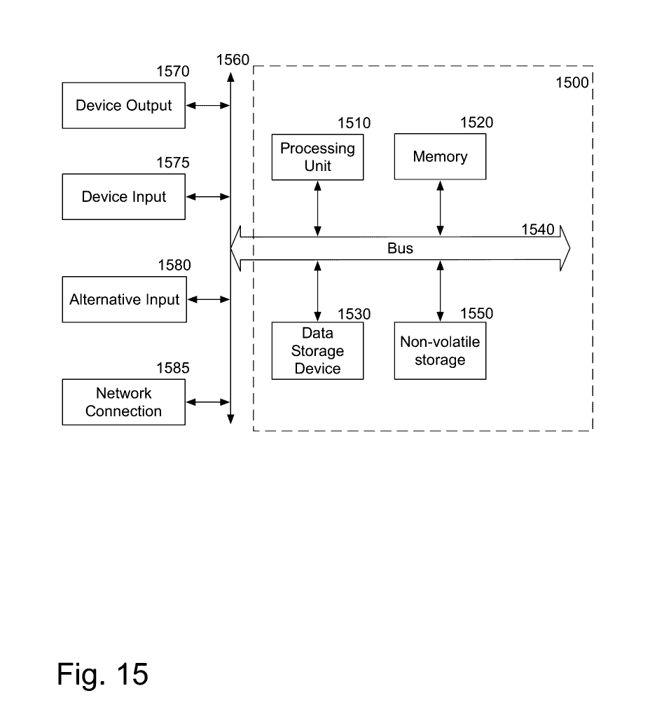

FIG. 15 is a block diagram of one embodiment of a computer system on which the present invention may be implemented.

The computer system actually utilized may be a distributed set of processors, used to render the image. In one embodiment, the rendering may take place on a single processor, a processor cluster, a cloud computing platform, or another mechanism to provide sufficient computing power to generate the data necessary to provide the accurate image rendering discussed above. In one embodiment, the user may display the results on a computer system, which may be a desktop, laptop, tablet, smart phone, or other computer system that has a network connection to obtain the data from the server, and sufficient computing power to display the data.

The data processing system illustrated in FIG. 15 includes a bus or other internal communication means 1540 for communicating information, and a processing unit 1510 coupled to the bus 1540 for processing information. The processing unit 1510 may be a central processing unit (CPU), a digital signal processor (DSP), graphics processing unit (GPU), or another type of processing unit 1510.

The system further includes, in one embodiment, a random access memory (RAM) or other volatile storage device 1520 (referred to as memory), coupled to bus 1540 for storing information and instructions to be executed by processor 1510. Main memory 1520 may also be used for storing temporary variables or other intermediate information during execution of instructions by processing unit 1510.

The system also comprises in one embodiment a read only memory (ROM) 1550 and/or static storage device 1550 coupled to bus 1540 for storing static information and instructions for processor 1510. In one embodiment, the system also includes a data storage device 1530 such as a magnetic disk or optical disk and its corresponding disk drive, or Flash memory or other storage which is capable of storing data when no power is supplied to the system. Data storage device 1530 in one embodiment is coupled to bus 1540 for storing information and instructions.

The system may further be coupled to an output device 1570, such as a cathode ray tube (CRT) or a liquid crystal display (LCD) coupled to bus 1540 through bus 1560 for outputting information. The output device 1570 may be a visual output device, an audio output device, and/or tactile output device (e.g. vibrations, etc.)

An input device 1575 may be coupled to the bus 1560. The input device 1575 may be an alphanumeric input device, such as a keyboard including alphanumeric and other keys, for enabling a user to communicate information and command selections to processing unit 1510. An additional user input device 1580 may further be included. One such user input device 1580 is cursor control device 1580, such as a mouse, a trackball, stylus, cursor direction keys, or touch screen, may be coupled to bus 1540 through bus 1560 for communicating direction information and command selections to processing unit 1510, and for controlling movement on display device 1570.

Another device, which may optionally be coupled to computer system 1500, is a network device 1585 for accessing other nodes of a distributed system via a network. The communication device 1585 may include any of a number of commercially available networking peripheral devices such as those used for coupling to an Ethernet, token ring, Internet, or wide area network, personal area network, wireless network or other method of accessing other devices. The communication device 1585 may further be a null-modem connection, or any other mechanism that provides connectivity between the computer system 1500 and the outside world.

Note that any or all of the components of this system illustrated in FIG. 15 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1520, mass storage device 1530, or other storage medium locally or remotely accessible to processor 1510.

It will be apparent to those of ordinary skill in the art that the system, method, and process described herein can be implemented as software stored in main memory 1520 or read only memory 1550 and executed by processor 1510. This control logic or software may also be resident on an article of manufacture comprising a computer readable medium having computer readable program code embodied therein and being readable by the mass storage device 1530 and for causing the processor 1510 to operate in accordance with the methods and teachings herein.

The present invention may also be embodied in a handheld or portable device containing a subset of the computer hardware components described above. For example, the handheld device may be configured to contain only the bus 1540, the processor 1510, and memory 1550 and/or 1520.

The handheld device may be configured to include a set of buttons or input signaling components with which a user may select from a set of available options. These could be considered input device #1 1575 or input device #2 1580. The handheld device may also be configured to include an output device 1570 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 1510, a data storage device 1530, a bus 1540, and memory 1520, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals, but may be configured and accessed through a website or other network-based connection through network device 1585.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1510. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

The present application and claims do not merely recite the performance of a business practice known from the pre-Internet world along with the requirement to perform it on computers or the Internet. Instead, the described solution is necessarily rooted in computer-technology in order to overcome a problem specifically arising in the realm of computer networks, in which accurate visual representations of models of physical objects become relevant. It should be clear that taken together as an ordered combination, the below claims recite an invention that is more than the routine computer usage, nor do the claims preempt every application of the idea but rather they recite a specific way to resolve a particular computer-network Internet-centric problem, which is unique to networks.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method of transforming a garment into a garment model and rendering a depiction of the garment, comprising:
obtaining a plurality of measurements of the garment;
creating the garment model for simulation, the garment model including a simulation model defining mechanical properties of the garment, and a rendering model including the fabric visual characteristics; and
generating a depiction of the garment model on a body shape.

2. The method of claim 1, wherein the body shape includes a plurality of landmarks, the landmarks defining locations to which guide points on the pattern are associated.

3. The method of claim 2, wherein a location of a landmark of the plurality of landmarks is selected based on measurements of the body shape.

4. The method of claim 1, further comprising:
selecting a pose for the body shape, for the depiction, based on the measurements of the body shape.

5. The method of claim 1, wherein the garment pattern has a plurality of sets of guide points, when the garment has a plurality of wearing configurations.

6. The method of claim 1, wherein obtaining the plurality of measurements of the garment comprises one of:
receiving a computer aided design (CAD) data set and where adjustment is required adjusting the CAD data based on actual measurements,
non-destructive acquisition by taking a plurality of high definition photographs of the garment to define each panel and connection, and
destructive measurement by cutting apart the garment to define each panel and connection.

7. The method of claim 6, wherein adjusting the CAD data comprises:
determining systematic differences between the CAD data and measured data from the garment; and
characterizing the systematic differences to create data for the adjusting.

8. The method of claim 6, wherein the non-destructive acquisition uses an acquisition rack including a plurality of lights and a flat surface to place the garment.

9. The method of claim 1, wherein taking a plurality of measurements comprises:
obtaining a plurality of high definition images of the garment;
defining one or more panels based on the images;
defining one or more connections between the panels, wherein each connection is one of a seam or another connection.

10. The method of claim 1, further comprising:
defining a base pattern including plurality of panels, and connections between the plurality of panels;
adding a plurality of guide points to the base pattern, the guide points used to rig a pattern onto the body shape;
wherein the garment model inherits the guide points from the base pattern.

11. The method of claim 10, wherein the connections between the panels define seams, buttons, fasteners, and non-seam connections.

12. The method of claim 1 wherein the base model of an item may be different for different sizes of the item, when the proportions of the panels are changed in the different sizes of the item.

13. The method of claim 1, further comprising:
analyzing a fabric of the garment to identify mechanical characteristics of the garment, the mechanical characteristics determining movement and drape behavior.

14. The method of claim 13, further comprising:
modeling the fabric characteristics in the garment by defining an anisotropic mesh based on the fabric characteristics, which buckles and forms wrinkles in a manner consistent with the fabric of the garment.

15. The method of claim 14, wherein the modeling utilizes anisotropic adaptive remeshing to adaptively adjust the mesh.

16. The method of claim 1, further comprising:
rigging the garment onto the body shape by stretching the garment, approximately aligning the guide points on the garment model and the landmarks on the body shape, and releasing the stretch, allowing the garment to naturally move onto the body shape.

17. The method of claim 16, further comprising:
checking validity of the depiction to determine if the garment model fits on the body model, the validity comprises detecting one or more of: excess stretch, visibility of private areas of the body, that the garment model has fallen off the body shape, improper alignment with landmarks, or unflattering appearance.

18. The method of claim 16, further comprising:
creating a depiction of the garment model creating a color map of a fit of the on the body model.

19. The method of claim 1, wherein the creating the depiction comprises:
utilizing fabric reflectance characteristics to capture view-dependent aspects of appearance.

20. The method of claim 1, wherein creating the depiction comprises:
using path tracing to compute global illumination, for rendering the garment model.

21. The method of claim 1, further comprising:
generating a subsequent garment model, the rendering of the subsequent garment model reusing previously computed data.

22. The method of claim 1, wherein the generating of the depiction comprises:
generating a plurality of garment models on the body form, wherein the interaction between multiple layers of the plurality of garment models is calculated, the interaction including one or more of: collisions, contacts, and constraints.

23. The method of claim 1, further comprising:
adding surface aspects to the body model, to select user surface characteristics.

24. The method of claim 1, further comprising:
generating a plurality of depictions of the garment model, each of the plurality of depictions showing a different configuration of the garment, pose of the body shape, or viewpoint.

25. The method of claim 1, further comprising:
enabling a user to customize the garment model, the customized garment model usable to manufacture a custom garment for the user.

26. The method of claim 1, further comprising:
pre-computing a plurality of garment models for a plurality of body models;
the generating of the depiction of the garment model comprising selection of one of the pre-computed garment models.

27. The method of claim 1, further comprising:
enabling a search by “similar fit” for consumers, where the similarity of fit is defined based on one or more of the base pattern, the body shape, or the fabric.

28. The method of claim 1, further comprising:
generating a personalized recommendations for a user, based on a match between the garment model, and a user's body shape model, wherein the personalized recommendation comprises one of: a look book including a plurality of garments rigged onto a body shape model of the user, or advertisements.

29. The method of claim 1, wherein a display shown to a user includes a complete display, including embellishments of the garment model, and accessories.

30. A system to generate a garment model from a garment, and render a depiction of the garment, comprising:
a measurement acquisition system to take a plurality of measurements of the garment;
a pattern generator to create the garment model for simulation, the garment model including a simulation model defining mechanical properties of the garment, and a rendering model including the fabric visual characteristics; and
a rigging, simulation, and rendering tool to generate a depiction of the garment model on a body shape.

31. The system of claim 30, wherein the body shape includes a plurality of landmarks, the landmarks defining locations to which guide points on the pattern are associated, and the locations of a landmarks based on measurements of the body shape.

32. The system of claim 30, wherein the measurement acquisition system comprises one of:
a communication logic to receive a computer aided design (CAD) data set, and the measurement acquisition system further to adjust the CAD data based on actual measurements,
an acquisition rack including a lighting system and a camera on which the garment may be placed for non-destructive acquisition by taking a plurality of high definition photographs of the garment to define each panel and connection, and
a communication logic to receive data after destructive measurement from a user, the destructive measurement comprising cutting apart the garment to define each panel and connection.

33. The system of claim 30, further comprising:
a base pattern generator to use data from the measurement acquisition system to define a base pattern including plurality of panels, and connections between the plurality of panels;
a guide point logic to add a plurality of guide points to the base pattern, the guide points used to rig a pattern onto the body shape;
wherein the garment model inherits the guide points from the base pattern.

34. The system of claim 30, further comprising:
a fabric characteristic measurement device to analyze a fabric of the garment to identify mechanical characteristics of the garment, the mechanical characteristics determining movement and drape behavior.

35. The system of claim 34, further comprising:
the pattern generator to model the fabric characteristics in the garment by defining an anisotropic mesh based on the fabric characteristics, which buckles and forms wrinkles in a manner consistent with the fabric of the garment.

36. The system of claim 30, further comprising:
a validator to check a validity of the depiction to determine if the garment model fits on the body model, the validity comprises detecting one or more of: excess stretch, visibility of private areas of the body, that the garment model has fallen off the body shape, improper alignment with landmarks, or unflattering appearance.

36. The system of claim 30, wherein generating a subsequent garment model reuses previously computed data.

37. The system of claim 30, further comprising:
the rigging, simulation, rendering system generating a plurality of depictions of the garment model, each of the plurality of depictions showing a different configuration of the garment, pose of the body shape, or viewpoint.

38. The system of claim 30, further comprising:
a customizing tool enabling a user to customize the garment model, the customized garment model usable to manufacture a custom garment for the user.

40. A method of creating a rendering of a garment for a user comprising:
obtaining measurements of the user;
generating a body shape for the user, the body shape comprising a computer generated representation of the user, including a plurality of landmarks defining locations for garments;
obtaining a garment model of a garment, the model obtained by:
obtaining a plurality of measurements of the garment;
creating the garment model for simulation, the garment model including a simulation model defining mechanical properties of the garment, and a rendering model including the fabric visual characteristics; and
rigging the garment pattern on the body model, by associating the landmarks on the body shape with guide points on the garment model; and
displaying the resultant body model with the garment to the user.

41. The method of claim 40, further comprising:
generating a personalized recommendations for the user, based on a match between the garment model, and a user's body model, wherein the personalized recommendation comprises one of: a look book including a plurality of garments rigged onto a body shape model of the user, or advertisements.
